(19) United States
(12) Patent Application Publication
(10) Pub. No.: US 2019/0050828 A1
(43) Pub. Date: Feb. 14, 2019

(54) METHOD AND APPARATUS FOR SELECTION OF AIRCRAFT PARTS

(71) Applicant: Power Werks, Inc., St. Charles, IL (US)

(72) Inventor: Ryan Sheley, St. Charles, IL (US)

(73) Assignee: Power Werks, Inc., St. Charles, IL (US)

(21) Appl. No.: 16/164,070

(22) Filed: Oct. 18, 2018

Related U.S. Application Data
(62) Division of application No. 15/352,180, filed on Nov. 15, 2016.
(60) Provisional application No. 62/287,731, filed on Jan. 27, 2016.

(51) Int. Cl. G06Q 10/00; G06Q 10/08

(52) U.S. Cl. CPC G06Q 10/20; G06Q 10/0875

(57) ABSTRACT

A method and apparatus for reviewing a bundle of documents relating to the trace history of a life limited part, such as a part for an aircraft engine, for possible acquisition of the part, and a method and apparatus for preparing a bundle of documents relating to the trace history of a life limited part for use by the review program. Documents relating to the part history are prepared for review by identifying the document category, inputting information from the documents, and highlighting information on the documents. As the prepared document bundle is reviewed, the reviewer is shown the documents by category, the collected information, and the highlighted portions. The reviewer may track their progress through the document bundle and may track the progress of other reviewers. The reviewers may approve the acquisition of the part based on the review.

### CROSS REFERENCE TO RELATED APPLICATION

The present application is a Divisional patent application of co-pending U.S. patent application Ser. No. 15/352,180, filed Nov. 15, 2016, which is incorporated herein by reference. The present application claims the benefit of U.S. Provisional Patent Application Ser. No. 62/287,731, filed Jan. 27, 2016, which is incorporated herein by reference.

### BACKGROUND OF THE INVENTION

### Field of the Invention

The present invention relates generally to a method and apparatus for selecting aircraft parts, and more particularly to a method and apparatus for selecting and evaluating used aircraft parts for rebuilding an aircraft engine.

### Description of the Related Art

Aircraft parts, particularly the rotating parts within an aircraft engine, have a limited lifetime of use as designated by the manufacturer. These parts are referred to a Life Limited Parts (LLP). The life limited part may be specified as being acceptable for use for a certain number of cycles or for a certain number of operating hours, or may have its lifetime defined by both cycles and operating hours. A cycle for an aircraft part is one take-off and one landing by the aircraft in which the part is installed.

Some aircraft are used for shorter distance flights and frequent take-offs and landings, for example a regional jet which makes stops every hour or two throughout the day, resulting in rapid accumulation of cycles for the aircraft parts. Other aircraft are used for long distance flights, resulting in rapid accumulation of operating hours on the aircraft parts but fewer cycles. Other aircraft are used for less frequent take offs and landings, for example an aircraft that is used for only a few, short-distance flights a week, resulting in parts that retain a high portion of the limited lifetimes.

When rebuilding an engine for a high use aircraft, it is desirable that all the parts used are either new or have a large portion of the part's lifetime remaining. An engine being rebuilt for a less heavily used aircraft, for example, may be able to use parts that have a smaller portion of the limited lifetimes remaining. There may be other reasons for rebuilding an engine of parts that have some of the part's limited lifetime used up.

An aircraft engine requires servicing when any one of the parts within the engine reaches the end of its limited lifetime. Servicing of the aircraft engine is an expense for the aircraft owner and results in down time for the aircraft. It is in the interest of the aircraft owner that the engine requires servicing less frequently. On the other hand, parts that have some portion of their lifetimes used are less costly, resulting in a cost savings when building an engine. It may be economical for an aircraft mechanic to build an engine for an aircraft of parts that have about the same amount of each part's lifetime unused.

For example, an engine part may be designated as having a limited lifetime of 20,000 cycles when new. If an engine is being serviced when other parts within the engine have 10,000 cycles left in their lifetimes and a part requires replacement, it can be a cost savings to use a replacement part that has about 10,000 cycles left rather than using a new 20,000 cycle part. Servicing of aircraft engines may result in removal of parts having some portion of their limited lifetime's remaining, sometimes a significant portion of the limited lifetime. For example, a part may be removed with 12,000 cycles left on the part. That part could be used in another engine for the rest of the part's limited lifetime. Aircraft owners or operators may seek to rebuild an engine of parts that all have at least a certain number of cycles or hours left on the part lifetimes. For example, a mechanic may build an engine of parts having at least 8000 cycles left in the lifetime. The engine will not require rebuilding until it has been used for 8000 take-off and landing cycles.

Prior to using a part that has less than its new limited lifetime remaining, the history and use of the part must be verified, often by several different people. Each part is provided with a birth document when new, and each time the part is removed from an engine or is installed in an engine, the status of the part is recorded on service documents, mechanic's reports and other documents. If the aircraft or the part changes ownership, documents associated with the part record the changes. Each time the part changes hands, a document showing the change is generated and provided with the part history. Incidents involving the aircraft, for instance water landings or other events, are recorded in documents associated with the part. When an aircraft or even an entire airline is bought or sold, the transfer is recorded in documents associated with the part. Ideally, all of the documents relating to the part are provided in the part history. Any missing documents or documents which lack a clear indication of the part, its history, and clear connections to other events and documents in the history may be problematic for validating the part history.

Each life limited part may be accompanied by a significant volume of documents. The documents are commonly provided as a bundle of physical documents, possibly including documents smudged with grease or fingerprints by the mechanic during servicing or other evidence of the source or history of the document. The documents may contain signatures or initials by mechanics, parts managers or others, or may include stamps, embossments, or other marks associated with that particular stage of a part's lifetime. The documents may be in different languages. The documents are often not uniformly formatted nor do they have the same information nor is the information presented in a uniform order or manner. Each mechanics shop or airline may use differently formatted maintenance release documents showing different information for a given event in the part's lifetime.

Verification of the part and its history requires review of each of the documents associated with a part. Several different people, such as MRO's, lessors, and operators, may be required to verify the documentation for each part prior to that part being used in an engine rebuild. Review of the bundle of documents can be time consuming for each person required to review the bundle. Persons tasked with reviewing the documents may put off the review for more pressing tasks or just because reviewing the document bundle is tedious. Considering the cumulative delay by all of the reviewers, the delays in obtaining verifications from all of the required reviewers may take a considerable amount of time. Persons tasked with obtaining the verification from each of the reviewers may spend considerable time making repeated inquiries to the reviewers in order to get the reviews completed.

### SUMMARY OF THE INVENTION

In certain embodiments, a review program provides guided review of a trace document bundle that shows the history of a life limited part (LLP) such as a part used in aircraft engines. The review program may guide the reviewer in the review, identify documents by type, highlight relevant information within the documents, present the documents by category, as well as providing other assistance to the reviewer. The review program shows the reviewer an indicator of the reviewer's progress through the document review. The review program permits other reviewers to be invited by the reviewer to review the document bundle and shows the reviewer the progress being made through the review by the other reviewers. Automatic notices or nudges may be provided to a reviewer.

In certain embodiments, the review program provides a communication channel by which the reviewers may communicate with one another. The communication channel may be used to communicate about the review or about other issues. The review program may also provide an archive for the document bundles.

In certain embodiments, a trace document bundle preparation program processes a trace document bundle relating to the history of a part for use in the review program guides a user in providing information on the trace documents that may be used in the trace document review.

### BRIEF DESCRIPTION OF THE DRAWINGS

FIG. 1 is a screen shot of an opening screen of a trace document review and tracking program showing a summary to the user;

FIG. 2 is a screen shot of the trace document review and tracking program showing adding of reviewers;

FIG. 3 is a screen shot of the trace document review and tracking program showing instructions, review progress, and reviewer tracking;

FIG. 4 is a screen shot of the trace document review and tracking program showing starting of the review;

FIG. 5 is a screen shot of the trace document review and tracking program showing a first document for review including highlighted portions;

FIG. 6 is a screen shot of the trace document review and tracking program showing matching of information;

FIG. 7 is a screen shot of the trace document review and tracking program showing addition of notes for transmission in the system;

FIG. 8 is a screen shot of the trace document review and tracking program showing finalizing review of the document bundle;

FIG. 9 is a screen shot of the trace document review and tracking program showing automatic approval of the document bundle;

FIG. 10 is a screen shot of the trace document review and tracking program showing a summary of the trace documents and review;

FIG. 11 is a screen shot of the trace document review and tracking program showing review progress by other reviewers;

FIG. 12 is a screen shot of the trace document review and tracking program showing sharing of approval and messages to other reviewers;

FIG. 13 is a screen shot of the trace document review and tracking program showing added page numbers and index numbers on a trace document;

FIG. 14 is a screen shot of the trace document review and tracking program showing a purchase option for the part;

FIG. 15 is a screen shot of a second embodiment of a trace document review and tracking program showing selection of a life limited part for review;

FIG. 16 is a screen shot of the second embodiment of a trace document review and tracking program showing a summary of the trace documents;

FIG. 17 is a screen shot of the second embodiment of a trace document review and tracking program showing initiation of a trace document review;

FIG. 18 is a screen shot of the second embodiment of a trace document review and tracking program showing the review progress screen;

FIG. 19 is a screen shot of the second embodiment of a trace document review and tracking program showing categories of documents for review;

FIG. 20 is a screen shot of the second embodiment of a trace document review and tracking program showing a document for review including markings on the document;

FIG. 21 is a screen shot of the second embodiment of a trace document review and tracking program showing progress through the document review;

FIG. 22 is a screen shot of the second embodiment of a trace document review and tracking program showing a further document for review;

FIG. 23 is a screen shot of the second embodiment of a trace document review and tracking program showing further progress through the review;

FIG. 24 is a screen shot of the second embodiment of a trace document review and tracking program showing a further document for review;

FIG. 25 is a screen shot of the second embodiment of a trace document review and tracking program showing progress in the review;

FIG. 26 is a screen shot of the second embodiment of a trace document review and tracking program showing completion of review by the reviewer;

FIG. 27 is a screen shot of the second embodiment of a trace document review and tracking program showing sharing of progress with other reviewers;

FIG. 28 is a screen shot of the second embodiment of a trace document review and tracking program showing selection of reviewers for the review;

FIG. 29 is a screen shot of the second embodiment of a trace document review and tracking program showing adding of reviewers for the review;

FIG. 30 is a screen shot of the second embodiment of a trace document review and tracking program showing a further reviewer being added;

FIG. 31 is a screen shot of the second embodiment of a trace document review and tracking program showing a summary of reviews;

FIG. 32 is a screen shot of the second embodiment of a trace document review and tracking program showing addition of reviewers;

FIG. 33 is a screen shot of the second embodiment of a trace document review and tracking program showing progress of reviewers being checked;

FIG. 34 is a screen shot of the second embodiment of a trace document review and tracking program showing progress of the review by another reviewer;

FIG. 35 is a screen shot of the second embodiment of a trace document review and tracking program showing downloading of the trace document bundle;

FIG. 36 is a screen shot of the second embodiment of a trace document review and tracking program showing completion of the review;

FIG. 37 is a screen shot of a trace document organizing and marking program showing entry of preliminary information;

FIG. 38 is a screen shot of a trace document organizing and marking program showing information being entered;

FIG. 39 is a screen shot of a trace document organizing and marking program showing a screen for selection of a trace document bundle;

FIG. 40 is a screen shot of a trace document organizing and marking program showing uploading of a trace document bundle;

FIG. 41 is a screen shot of a trace document organizing and marking program showing progress in uploading of the documents;

FIG. 42 is a screen shot of a trace document organizing and marking program showing a document being categorized and marked;

FIG. 43 is a screen shot of a trace document organizing and marking program showing guidance for a user to mark and categorize the displayed document;

FIG. 44 is a screen shot of a trace document organizing and marking program showing entry of information from the displayed document;

FIG. 45 is a screen shot of a trace document organizing and marking program showing selection of a document type;

FIG. 46 is a screen shot of a trace document organizing and marking program showing a guide for the user to locate and enter information from the document;

FIG. 47 is a screen shot of a trace document organizing and marking program showing guidance for a user for entry of information from the document;

FIG. 48 is a screen shot of a trace document organizing and marking program showing questions for a user to answer about the document;

FIG. 49 is a screen shot of a trace document organizing and marking program showing a question to the user to aid in classification of the document;

FIG. 50 is a screen shot of a trace document organizing and marking program showing selection of information concerning the document;

FIG. 51 is a screen shot of a trace document organizing and marking program showing a request for information about the document;

FIG. 52 is a screen shot of a trace document organizing and marking program showing a request for further information about the document;

FIG. 53 is a screen shot of a trace document organizing and marking program showing a summary of the document bundle and requesting finalization;

FIG. 54 is a screen shot of a trace document organizing and marking program showing finalization of the document bundle; and

FIG. 55 is a functional block diagram showing the document bundle processing program and the document bundle review program.

### DETAILED DESCRIPTION

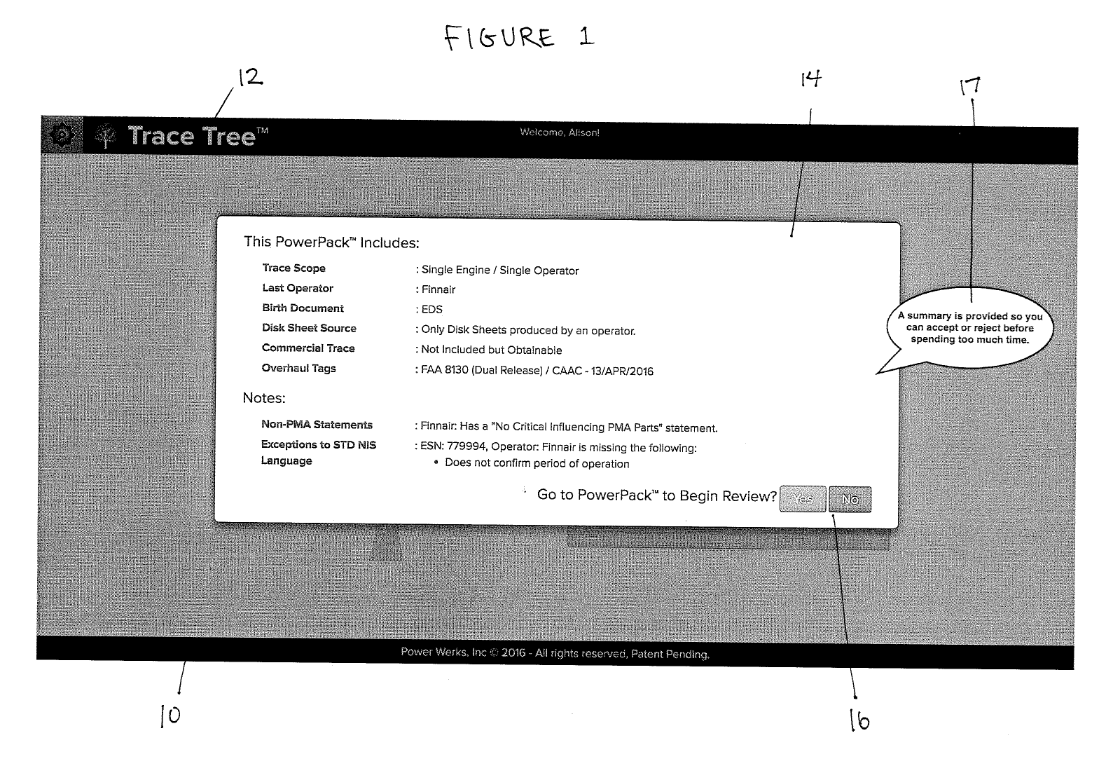

Referring first to FIG. 1, a computer device such as a desktop computer, laptop computer, tablet computer, smart phone, work station, personal digital assistant, smart display, game system, kiosk, notebook computer, or other device has a display on which is provided information including screen information according to the following. The computer device may include a processor, working memory or RAM, and may include storage memory such as solid state memory or hard disk memory, although the storage memory is not required in every instance. The computer device includes a user input such as a touch screen, keyboard, mouse and/or other input and/or pointing device. The computer device is used to view the screen 10 shown in FIG. 1.

In FIG. 1, the screen 10 shows a banner 12 identifying the program as the review program for reviewing a bundle of trace documents relating to the history of an aircraft part. In the example, the program is called the Trace Tree™ program. The screen view 10 shows a window 14 in which is provided a summary of a bundle of trace documents relating to an aircraft engine part that the reviewer may choose to review.

The documents relating to the aircraft part have been compiled, reordered and in some cases have been highlighted for the convenience of the reviewer. A review structure is provided to enhance the review process. The review program does not warrant that the documents are free of alternations or errors, nor does the program evaluate or warrant the information and documents provided by third parties.

The bundle of documents is referred to in the example as a PowerPack™ bundle. The information in the summary indicates the trace scope, the last operator of an aircraft that included the aircraft part, the birth document for the aircraft part, disk sheet sources, commercial trace and overhaul tags. Notes are provided, which here are non-PMA statements and exceptions to STD NIS language. The information provided at each of these entries may permit a reviewer to make a decision to accept or reject the review of the document bundle without the need to review the document bundle itself.

The document review program may also serve as an archive for trace documents. The trace documents for parts to be reviewed and for parts that have been reviewed may be stored, cataloged and retrieved using the document review program.

The trace scope indicates in the example that the trace document bundle shows use of the part in a single engine and by a single operator. The last operator is the name of the airline that last used the part. The birth document indicates EDS. The disk sheet source indicates that the trace includes only disk sheets produced by an operator. The commercial trace indicates that the commercial trace is not included but is available.

The banner 12 includes buttons 16 that accept the prospective reviewer's input to either accept or reject the review after seeing only the summary information. The buttons 16, as well as any and all buttons and other control inputs to the program shown and/or described herein, may be displayed as buttons, links, controls or other inputs or things without limiting the invention claimed herein. For sake of simplicity, the term button will be used in this specification but is to be understood as any input means.

In a demonstration version of the review program, information balloons are provided to identify elements of the program for a prospective user. The illustrations show the demonstration version of the program with the information balloons. Commercial versions and other versions of the program will not include the information balloons. An information balloon 17 informs the user that a summary is provided for a part that the user may accept or reject before spending time reviewing the document bundle. The information balloon 17 is but one example of information that may or may not be provided to the user by the program. Other dialog boxes, signs, indicia or other means for providing information to the user may be provided within the scope of this invention and any or all of which are included when reference is made to information balloons. The information balloons are provided in a demonstration version of the program, as noted above, and may be provided as a feature of the program or not as desired. The display of the information balloons may be turned on or off by the user or by the program provider in certain embodiments.

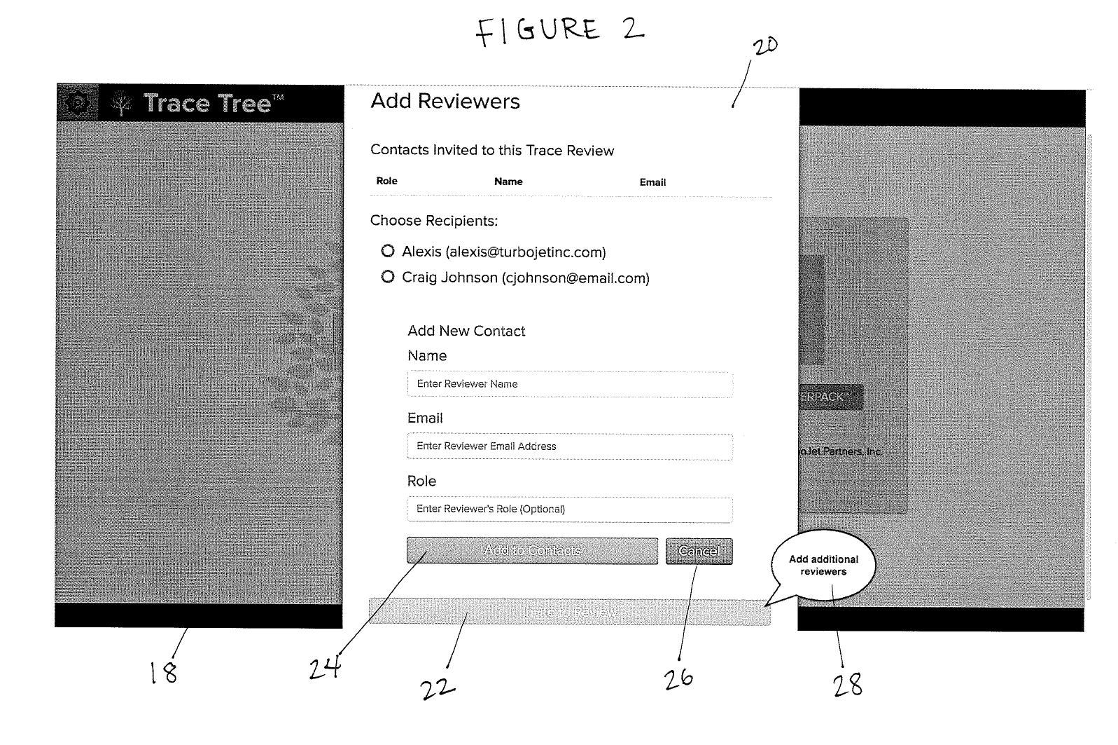

If the prospective reviewer opts to review the trace document bundle, the screen 18 of FIG. 2 is displayed. The prospective reviewer, who may at this stage be referred to as a reviewer, is shown a window 20 that receives information on other reviewers to be added to the trace document review. In the example, the added reviewers are identified by name, email address, and their role as it relates to the aircraft part being considered. For example, here the added reviewer is identified as a lessor of the aircraft or engine. The reviewer may select a button 22 “Invite to Review” to add the person as an added reviewer. The reviewer may select a button 24 to add the person to a contact list, for example, for future reviews. A cancel button 26 is also provided to cancel the review. An information balloon 28 is provided to inform the user that the user may add additional reviewers.

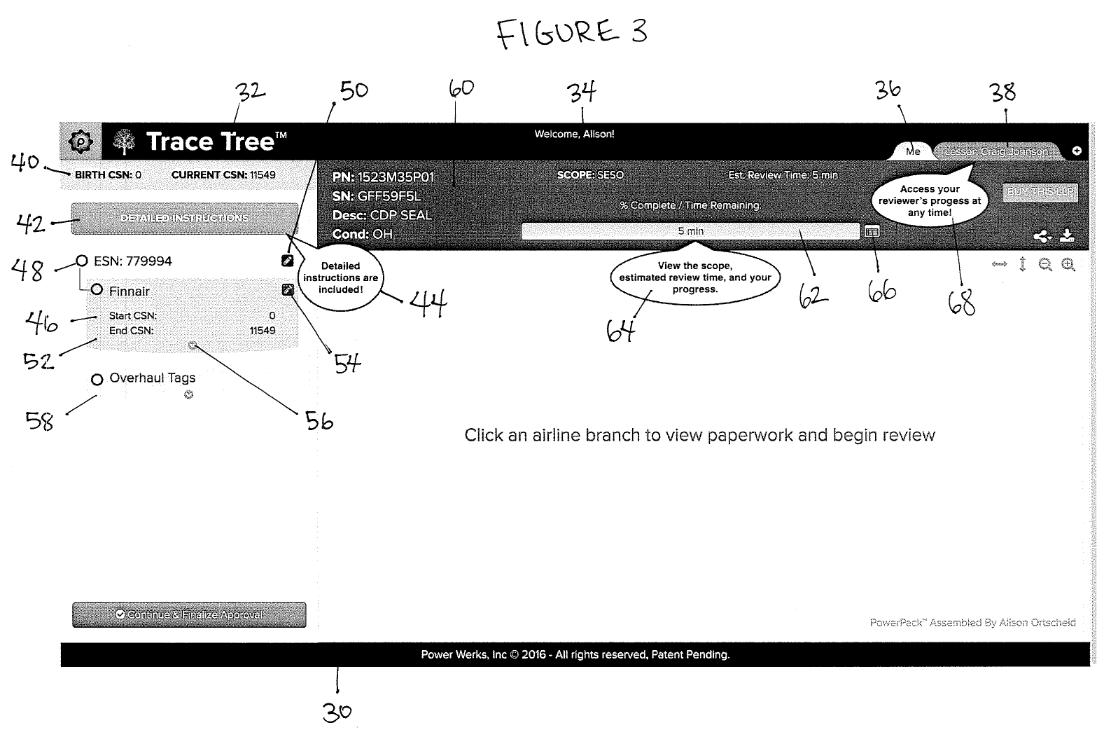

In FIG. 3, the reviewer has opened the electronic document bundle by electing to begin the review and by choosing reviewers. A review screen 30 is shown on the computer device. The review screen 30 includes a banner 32 identifying the program as the TraceTree™ document review program and welcomes the reviewer by name at 34. A tab 36 is identified as “me” that shows the user's review information when selected. An additional tab 38 is provided for each additional reviewer added to the review program. The user has selected the “me” tab 36 to view their own screen.

At the user screen is shown a column 40 that shows the current cycle numbers for the Life Limited Part (LLP). Here, the birth CSN (cycles since new) is zero and the current CSN is 11,549. This indicates that the part started at zero cycles when first made and has been used in an aircraft for 11,549 take-off and landing cycles. If the part has a limited life of 20,000 cycles, the part has a little less than half of its life left. The reviewer may see at a glance is the part matches their requirements for available life. In the column 40 is provided a button 42 for the user to request detailed instructions. An information balloon 44 is provided informing the user that detailed instructions are included. Below the button 42 is an outline 46 that shows the significant information and documents in the document bundle.

The document bundle may include many other documents that are not relevant to the review being conducted here and thus are not listed or need not be examined. If the document review were being handled without the present review program, the reviewer may find it necessary to examine most if not every document in the bundle. By guiding the reviewer through the document bundle, the review program reduces the time for a trace document bundle review and permits the user to stay focused on the information relevant to the review.

In the illustrated example, an ESN (engine serial number) 48 is shown with an edit button 50. Below the ESN number 48 is a shaded area 52 that may be provided for each operator that used the part. Here, a single operator or airline used the part for all of its use life to date. Where a part has been used by several operators, multiple operators and multiple ESNs may be shown at a glance by multiple shaded boxes 50. The shaded area 52 shows the operator by name and the start and end cycle numbers for the part while the part was being used by that operator. An edit button 54 is provided for the shaded area 52. A drop down arrow 56 is provided in this example to indicate that more information is available than that shown. A further shaded area 58 shows that the document bundle includes overhaul tags. Each significant document or type of document in the document bundle may have its own shaded area so that the reviewer may see the relevant contents of the document bundle at a glance.

Below the banner 32 and to the right of the column 40 is an information panel 60. The information panel 60 provided details on the part being reviewed, including the part number, the serial number, a description and its condition. Here, the part is a CDP seal (a part used in an aircraft engine) and the condition is OH. Of course, the program may be used for any part in any condition. The review program is particularly useful for review of documents relating to life limited parts that retain some of their useful lives and so could be used again, possibly in a different engine or even in the same engine. The review program may be used for review of other documents for other reasons.

At the center of the information panel 60 is a progress bar 62 that shows the user's progress through the document review. The progress bar 62 shows the percentage completed and the time remaining. An estimate of the amount of time required for the review is provided in the progress bar 62 and in an estimated time listing above the progress bar. Here, the program estimates that the document review will require five minutes of the user's time. The scope of the review is also indicate, here shown as SESO. An information balloon 64 may be provided to indicate to the user that the scope, estimated review time and the user's progress are indicated by the progress bar 62. An added button 66 is provided adjacent the progress bar 64.

A user who is accustomed to spending a long time reviewing a document bundle, either because it is poorly organized, because it is voluminous, or both, may be reluctant to start a review. The indication of the time required for the review of the well-organized document review may encourage early review of the document bundle by the reviewer.

The user may select another reviewer's tab at 38 to check on the progress of the other reviewer, as indicated by the information balloon 68. Further process flow commands are provided on the screen 30, as will be discussed herein.

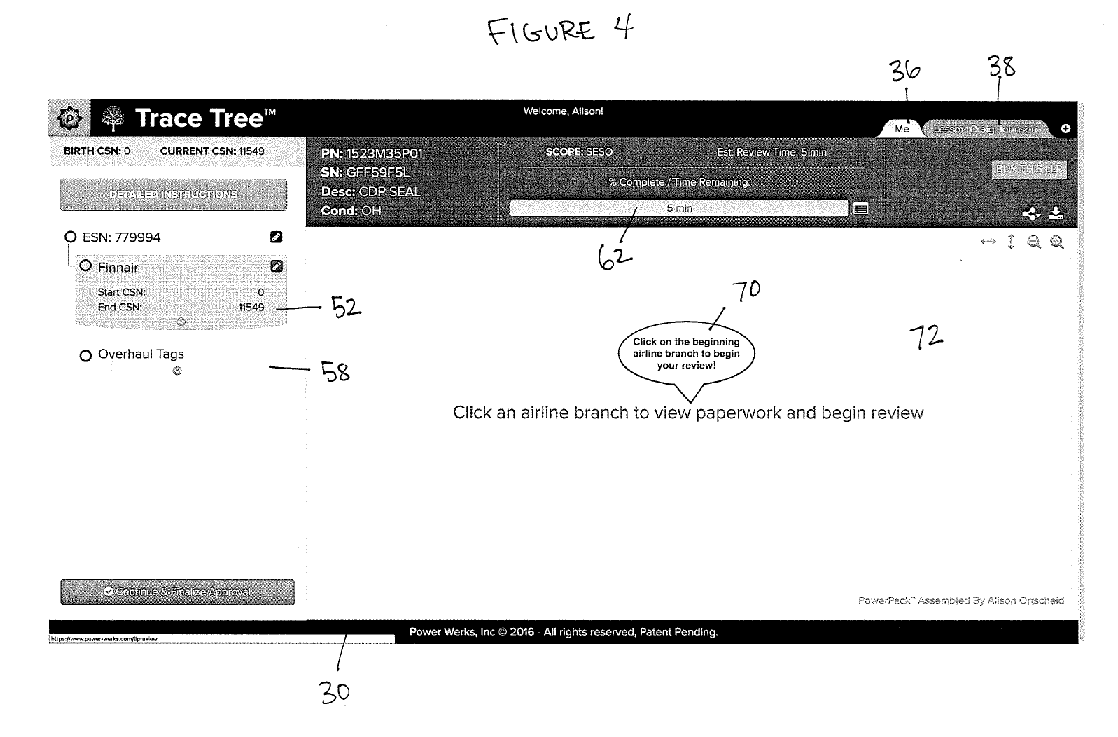

In FIG. 4, the screen 30 is shown with an information balloon 70 informing the user that the user may begin a review by selecting an airline branch (the shaded area 52) to view the paperwork for that airline's use of the part. The information balloon 70 suggests clicking on the beginning airline. Text in the document view window 72 provides the same information.

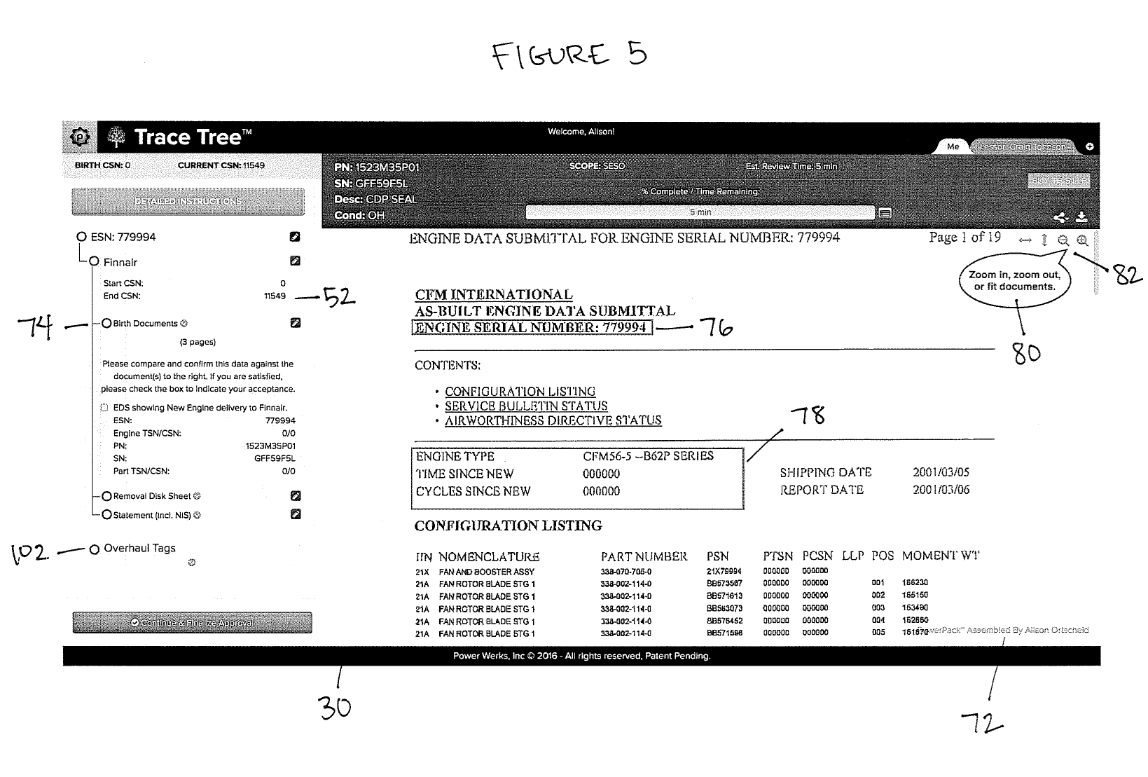

Turning to FIG. 5, the user has selected the first shaded area 52, which results in the shaded area 52 expanding to show a listing of documents and/or document types relating to that airlines use of the life limited part. In the expanded shaded area 52, the name of the operator and the CSN (cycles since new) values for the start and end of that operator's use of the part are shown as before. In addition, categories of documents are listed. The first category 74 is birth documents relating to the first use of the part in an aircraft engine. The first category 74 has been selected by the user. The expanded shaded area 52 indicates that the birth document is three pages in length. It indicates that an EDS shows that the part was installed into a new engine that had zero time since new (TSN) and zero cycles since new (CSN). The engine serial number into which the part was installed, the airline to which the engine was delivered, the part number, the serial number, and the time since new and cycles since new values for the part are shown in the shaded area 52 for the user's convenience.

The document view window 72 shows an image file of the selected documents. Here, the document details the builder of the engine, lists the parts used in the engine and their names, part numbers, serial numbers and limited life status. The reviewer may wish to review all of the information found on this multiple page document, but may need to check only a few key information items prior to accepting or refusing the purchase of the part. Key information commonly checked by most reviewers is highlighted on the image of the document. In this information, the highlights are by boxes 76 and 78 that have been drawn onto the image of the document. Other highlights are of course possible.

In the example, the box 76 highlights the engine serial number into which the part was installed when new. The box 78 highlights the engine type and the engine life information, time since new and cycles since new, which here are zero indicating a new engine. An information balloon 80 indicates document view controls 82, including zoom in, zoom out, fit, pan, and possibly others.

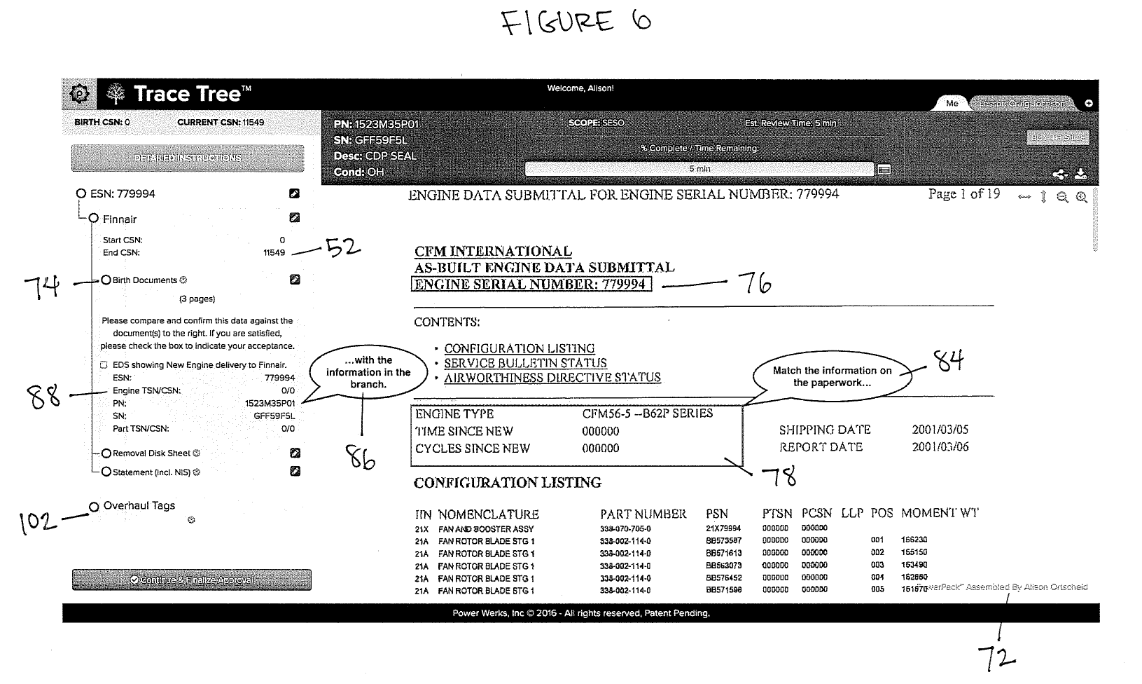

With reference to FIG. 6, the information balloons 84 and 86 asks the user to compare the information shown on the document with the information shown on the information branch 88 of the shaded area 52. The user may compare part numbers, serial numbers and other information in the shaded area 52 against the information shown in the documentation. The example shows that much more information is provided on the document partially off screen in the example. This information may include part numbers, etc. for the part being investigated. The user may need to scroll to the additional information, which may be highlighted in other parts of the document.

The user may need to verify that the documents in the document bundle relate to the part being investigated, that the numbers, dates, and other information match, or check for other information on the documents prior to approval of the part. The user may move through the document pages, zoom in or out or otherwise examine the documents as needed. When the document is presented to the reviewer, the review program identifies the type of document to the reviewer. The reviewer is not left to guess what type of document it is. The documents may have a variety of different appearances and formatting so that the type of document that might not be readily apparent to the user. The review program may have highlighted portions of the document. The documents may have many different types of information, and sometimes large volumes of information, which may otherwise result in the user spending a long time looking for the needed information on the document. The user need not look through what may potentially be volumes of information on the document to find the needed information. The review program shows the user as separate information in the shaded area the information that may be important in the review. The reviewer need not remember or separately record the information for comparison.

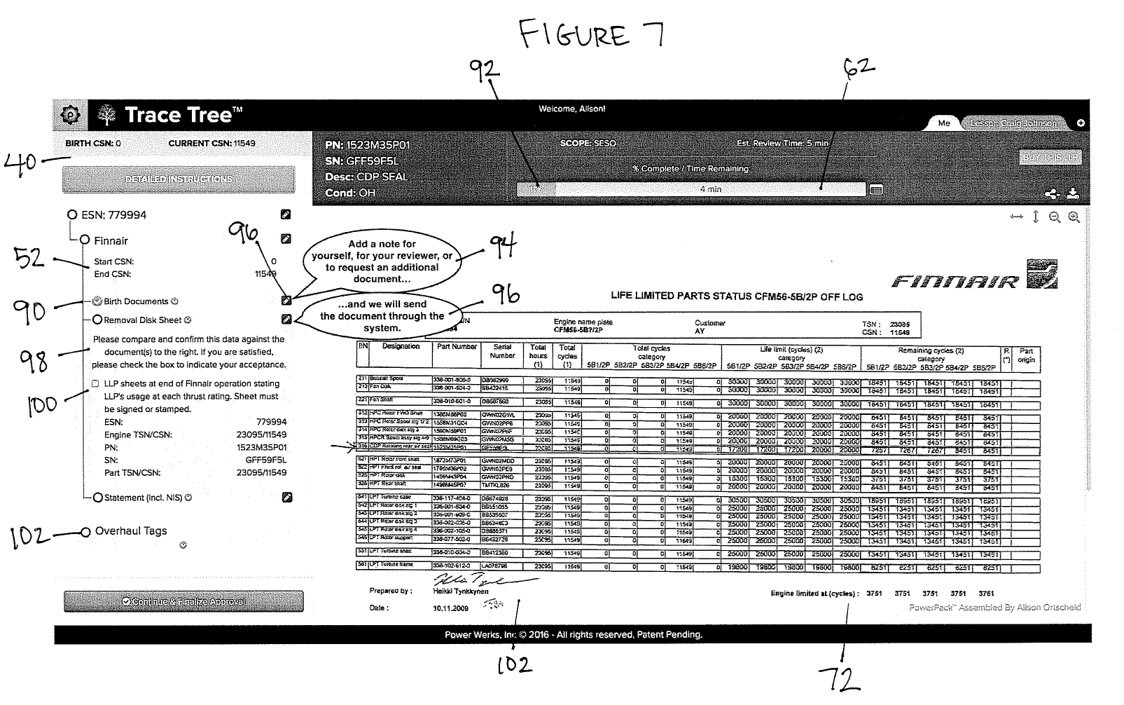

In FIG. 7, the reviewer has completed the review of the birth documents as indicated by a check mark in circle 90. The progress bar 62 shows a colored bar 92 to indicate that that a percentage of the review has been completed. The review program automatically displays documents in the next category for review. Here, part removal documents are shown, or what is referred to as a removal disk sheet document. The removal document is shown in the document window 72. It provides information about the removal of the part from the aircraft engine. In the example, an “off log” is shown. In this document, the information previously labeled as engine type is identified on this document as an engine name plate. Thus, the information presented may not be consistently labeled from one document to the next. Regardless of the labeling of the information on the document, the relevant information is highlighted on the document.

The aircraft parts removed in the removal operation are listed on the displayed document and the part of interest is highlighted in the displayed document by the review program. As can be seen in the example, a lengthy list of the parts removed from the aircraft engine during the removal operation is shown in fine print, making unassisted review of the document a challenge for the reviewer who must locate and confirm the information on one of the listed parts. By presenting the document with an identification of the document type and the relevant information that could be found on the document in the column 40, along with highlights on the document image of that show where the information is found on the document, the reviewer's time for the review is reduced significantly.

An information balloon 94 is shown in FIG. 7 that indicates a note button 96. Selecting the edit button 96 takes the user to a screen where the user may add a note to the file which may serve as a reminder for later. The note may be transmitted to another reviewer who is reviewing this document bundle. The note may also include a request for an additional document or for a corrected document. In response to a document request note, as indicated in information balloon 96, the requested document may be sent to the user through the system. In particular, a requested document may be provided to the reviewer as a document within the review program.

An instruction 98 is shown in the shaded area reminding the user to “Please compare and confirm this data against the document(s) to the right. If you are satisfied, please check the box to indicate your acceptance.” A check box 100 is provided for the user to check if satisfied. The check box 100 includes text describing and interpreting the displayed document. Here, the text says “LLP sheets at end of Finnair operating stating LLP's usage at each thrust rating. Sheet must be signed and stamped.” The reviewer is thus guided by the review program to look for a signature or stamp on the sheet along with the information on the usage data. In the document image can be seen the signature of a preparer of the document, which the reviewer may confirm as part of the review.

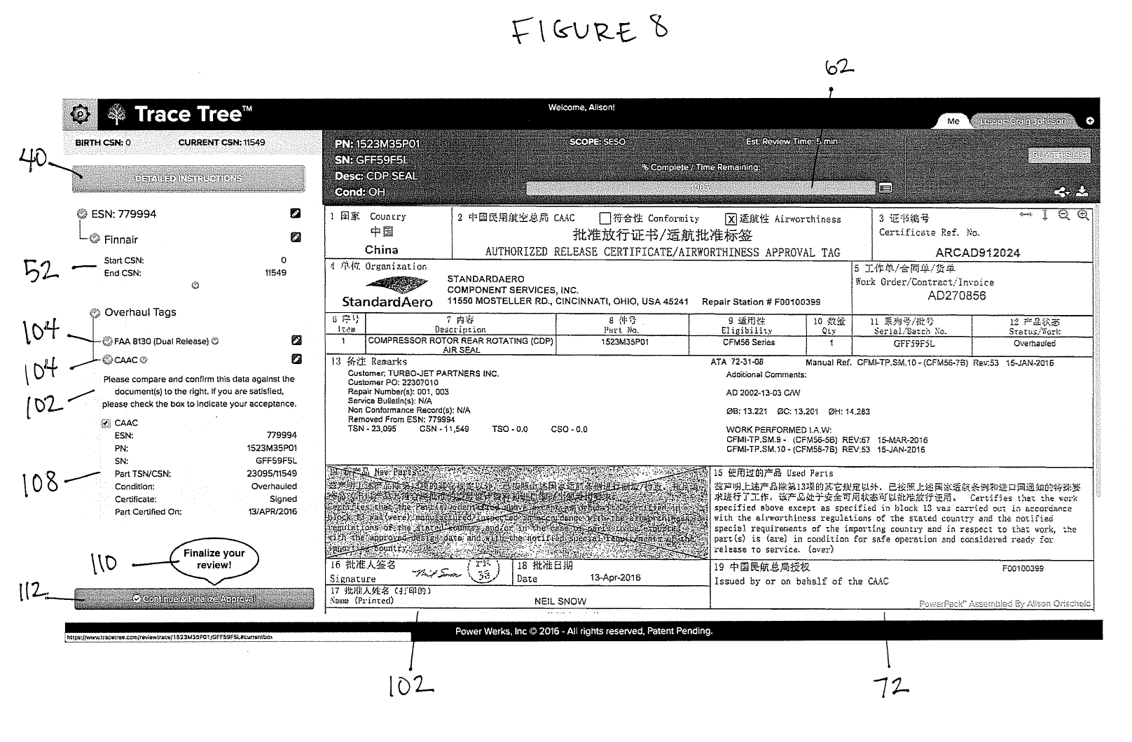

In FIG. 8, the reviewer has completed the review of the removal document and has opened the documents in the overhaul tags shaded area 102. The overhaul tags area 102 shows two entries 104 that require review by the reviewer. The reviewer has reviewed documents within both of the entries 104 and has checked the boxes confirming that the user has reviewed each entry and is satisfied. At each entry 104 is provided a note button 96 by which the reviewer may make notes for themselves or others or request additional documents. Each entry 104 is provided an arrow symbol 106 indicating that additional information on the documents located within that entry is available to the user. The edit buttons 96 and additional information arrows 106 are used throughout the review program for each entry in each shaded area of the column 40.

The document review window 72 shows the final document to be reviewed by the reviewer. The document in the example is in Chinese and English and reports overhaul of the part in question. The documents may be in any of several languages based on where the document originated and also on which civil authority regulates use of the parts. For example, a dual release document may release the part for use under two civil authorities, typically the FAA (Federal Aviation Administration) and the EASA (a European aviation authority). A tri-release document may release a part for continued use under three civil authorities, typically the FAA, EASA and the CAA (a Chinese aviation authority). A signature 102 and stamp are provided on the document. The information on the document may be checked against the information 108 shown in the shaded area 102. The information 108 provides information on the time since new and cycles since new for the part, the certification date, the certification signature, the part number and part serial number and the engine serial number, in this example.

The user has checked all of the necessary information and checked each box. The progress bar 62 shows the user that the review has been completed. An information balloon 110 asks the user to finalize the review, which may be performed by selecting the button 112 to continue and finalize approval.

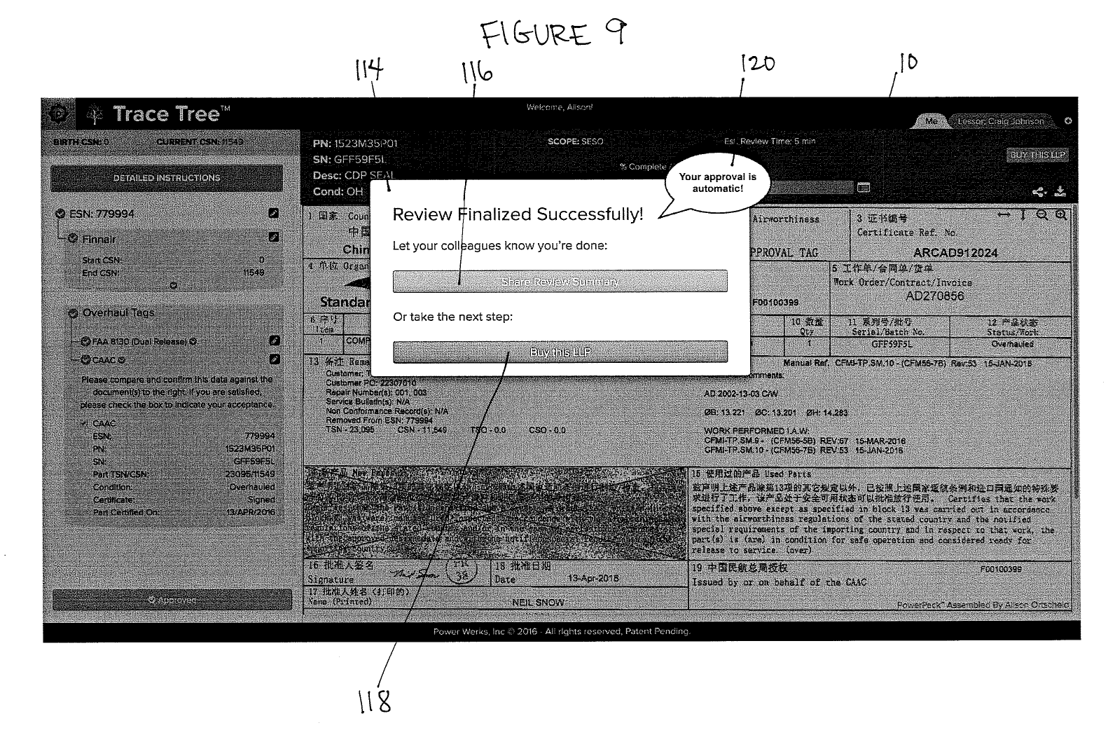

FIG. 9 shows the screen 10 after the user has finalized the review. A dialog box 114 is displayed which announces to the user that the review has been finalized. Two options are provided for the user. A first button 116 permits the user to share a summary of the review with others, for example, with other reviewers or with others who may be waiting for the user to complete the review. A second button 118 permits the user to purchase the life limited part (LLP) that has been the subject of the review. For instance, if the reviewer is the final reviewer required prior to making the purchase decision, or if the reviewer is the decision maker for the purchase, the user may select the button 118 resulting in the review program sending an order to purchase the part. An information balloon 120 informs the reviewer that the approval by the reviewer is automatic. In other words, the reporting of the review results is handled by the review program. Another reviewer who checks on the progress by this reviewer will see that this reviewer has completed the review of the document bundle for the part.

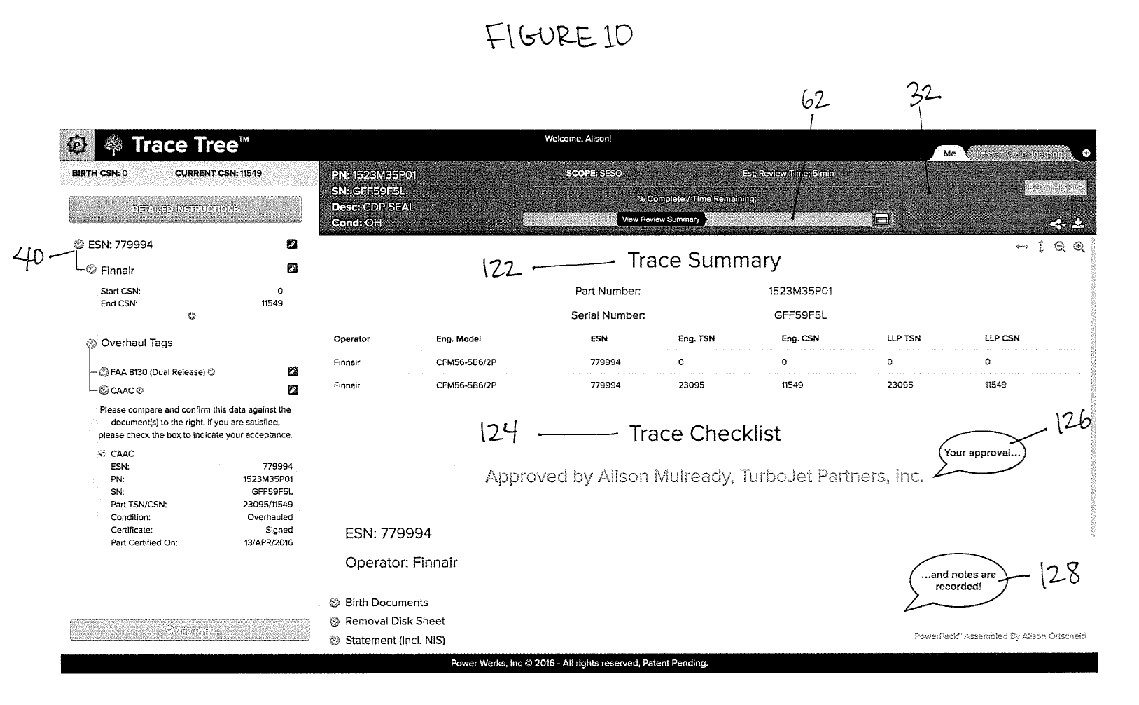

In FIG. 10 is shown summary information. The screen 10 still shows the information relating to the life limited part being considered for purchase including the information in the column 40 and in the banner 32. The progress bar 62 shows that the reviewer has completed the review. In the document view window 72, is provided a trace summary 122 that gives the significant events in the use life of the part including the operator and engine information when the part was first installed and the operator and engine information when the part was removed from the engine and each change in operator or engine in between. Time since new and cycles since new information are provided for the engine and for the part.

A trace checklist 124 is provided that shows the reviewers and the status of the review. In the example, the trace summary reports that one of the reviewers has approved the purchase of the part. An information balloon 126 informs the user that their approval is shown in the trace checklist 124. An information balloon 128 informs the user that their notes have been recorded. The information balloon 128 flags a note that the user has added to the document bundle. In particular, the user note is linked to the removal disk sheet, one of the categories of documents listed in the shaded area 42. Other notes by this user or by other reviewers may be linked to this or other documents in the document bundle.

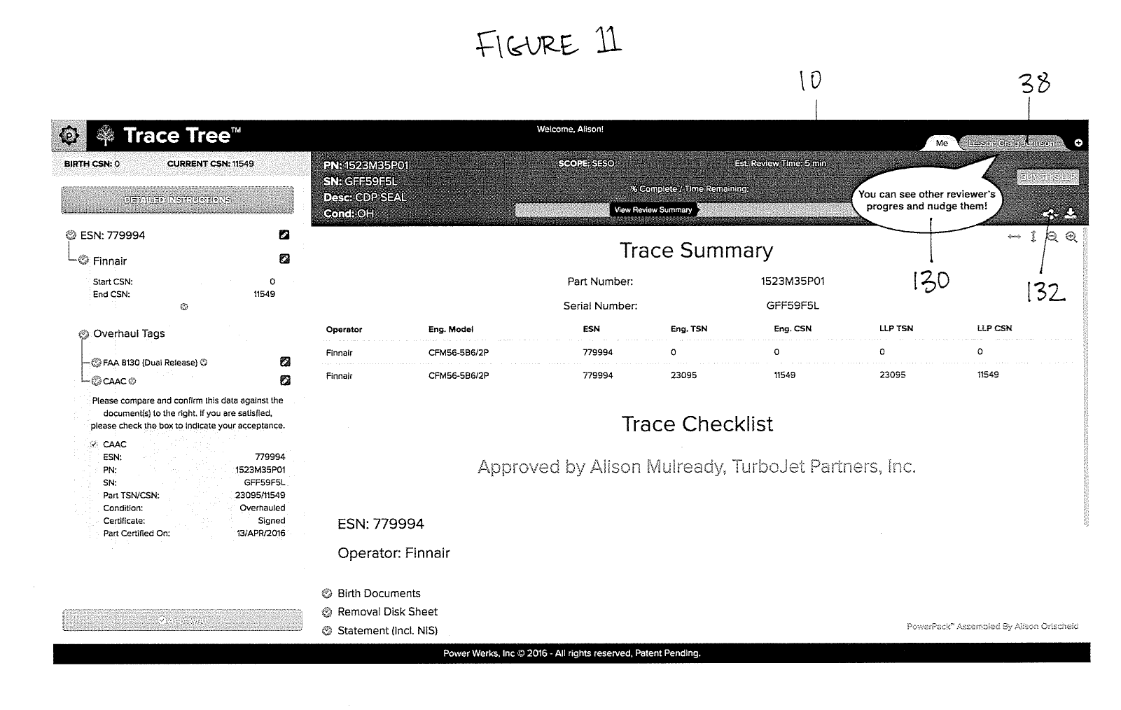

FIG. 11 shows an information balloon 130 that directs the user to tabs for other reviewers. The user may select a tab 38 of another user. When the tab 38 of another user is selected, the progress of the other reviewer in the review is shown. While viewing the progress screen of the other user, a nudge occurs automatically which notifies the other user that the first user is still waiting for a review to be completed. The notification or nudge is automatically generated by the system. It is possible for the first reviewer to send a message to that other reviewer, such as to encourage them to complete the review. FIG. 11 also shows that a button 132 that permits the user to purchase the life limited part at any time in the process.

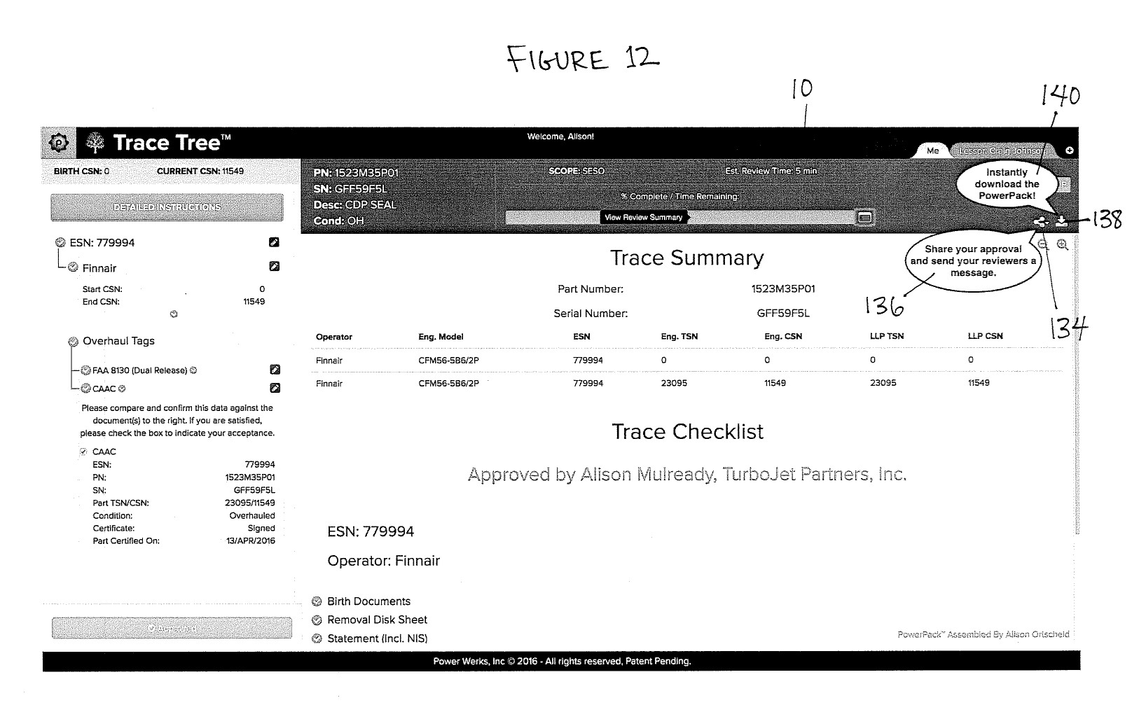

FIG. 12 shows that the screen 10 has commands for access at any time to a share command 134 that permits the user to share the approval of the part and to send reviewers a message, as indicated by an information balloon 136. The user may also select a download command 138 at any time. The download command 138 causes the review program to download the document bundle, as indicated by an information balloon 140. The balloon 140 informs the user that the download command instantly downloads the PowerPack document bundle.

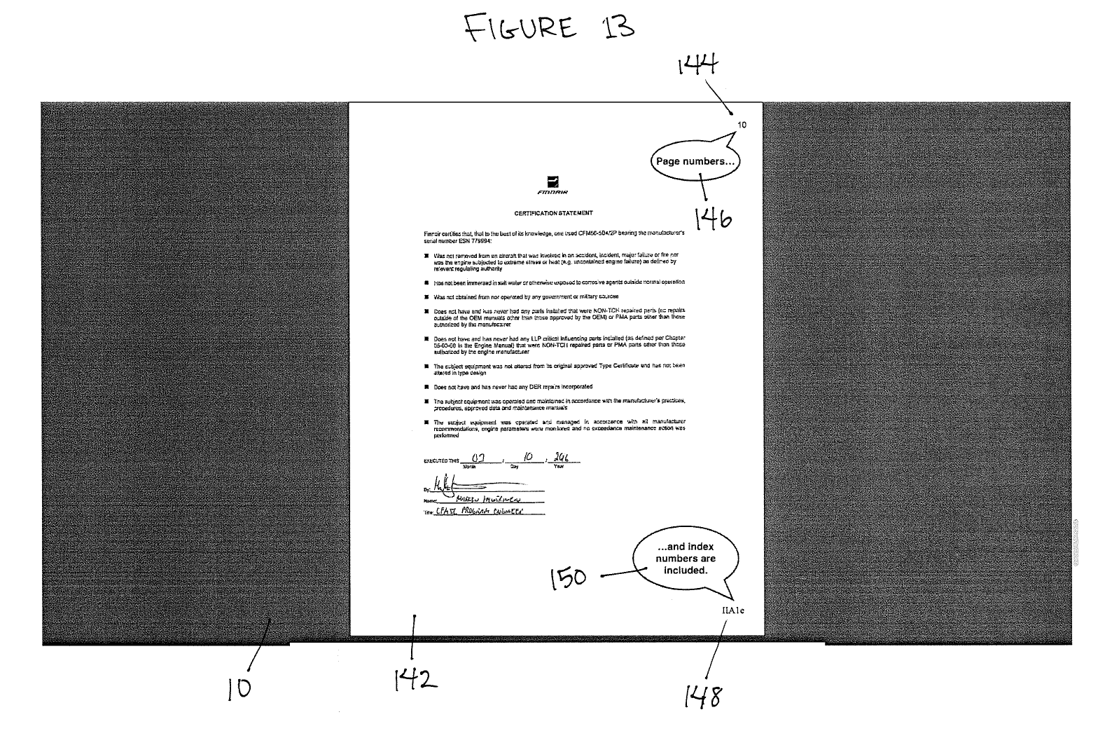

With reference to FIG. 13, a document 142 from the document bundle is shown on the screen 10 in full screen mode. The document may also be viewed within the document view window 72. The document 142 of the example is a signed certification statement relating to the part. To assist the reviewer in tracking the documents that have been assembled into the document bundle, the review program adds page numbers 144 to the document 142 as indicated by the information balloon 146. The review program also adds index numbers 148 as indicated by the information balloon 150. The index numbers may index the document in any way desired. For example, the index numbers may indicate the category or type of document, or may identify some characteristic or time in the use of the part, or some other index criteria. The index numbers promote and provide a standardized format for the documents.

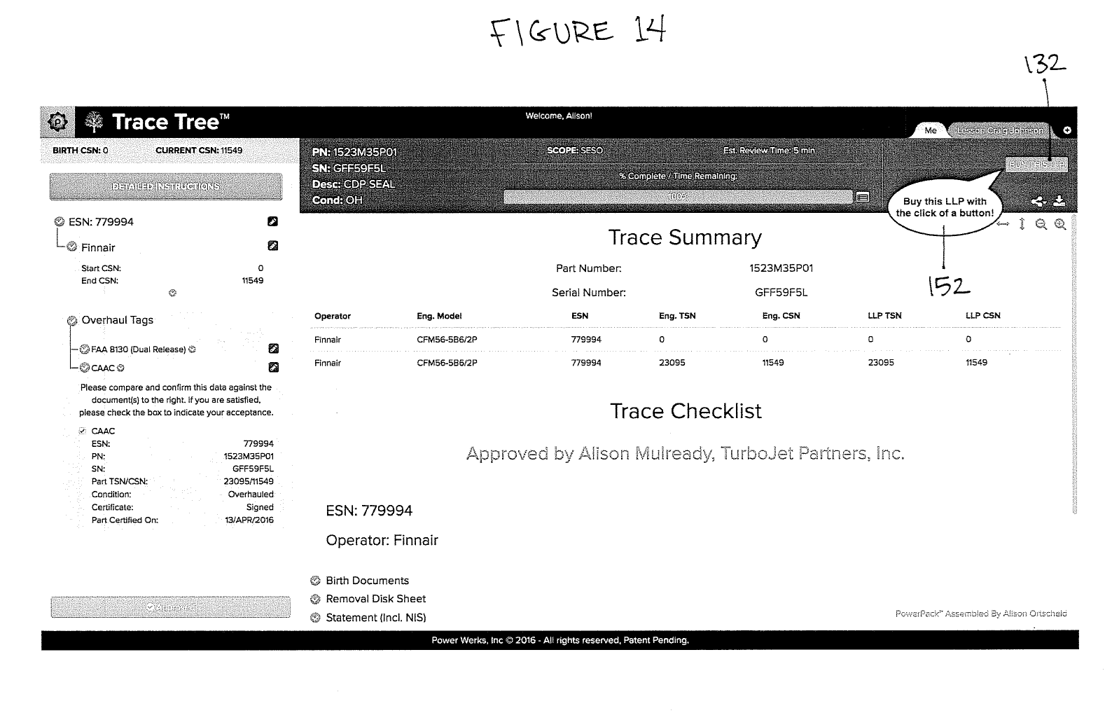

In FIG. 14, the screen 10 includes the buy this LLP button 132 with which the user may cause the review program to transmit a purchase order for the part. An information balloon 152 indicates that the user may buy the part with the click of the button 132.

The information balloons shown in the foregoing figures may be displayed to a user in a demonstration version of the program, or when training to use the review program. The information balloons may be selectively displayed, such as when needed by the user or when desired by the provider for training or demonstration. For example, the user may select display of the information balloons while learning to use the review program and then turn off the information balloons after gaining experience with the program. Many embodiments of the review program may not use the information balloons.

The review program has received a bundle of documents, which may or may not have been configured with special features for review, and has presented the documents to a reviewer for review while displaying the reviewer's progress in the bundle review. The reviewer is guided in the review to look for certain information in the documents and is provided with a means in the review program to indicate that certain information is present in the bundle. The review program of certain embodiments categorizes the documents in the bundle to permit the reviewer to examine documents of a category as desired. Certain embodiments permit the user to monitor the progress of other reviewers in the bundle review and to correspond through the review program about the review and other things. In certain embodiments, the review program facilitates the review by providing an outline of the documents in the document bundle, added page and section numbers that refer to the bundle as a whole instead of to individual documents within the bundle, highlighted sections in the documents that correspond to information to be verified as listed in the outline, and may include information balloons to guide a user in the review. The review program processes the document bundle to aid the reviewer in the review and to communicate the results of the review to others.

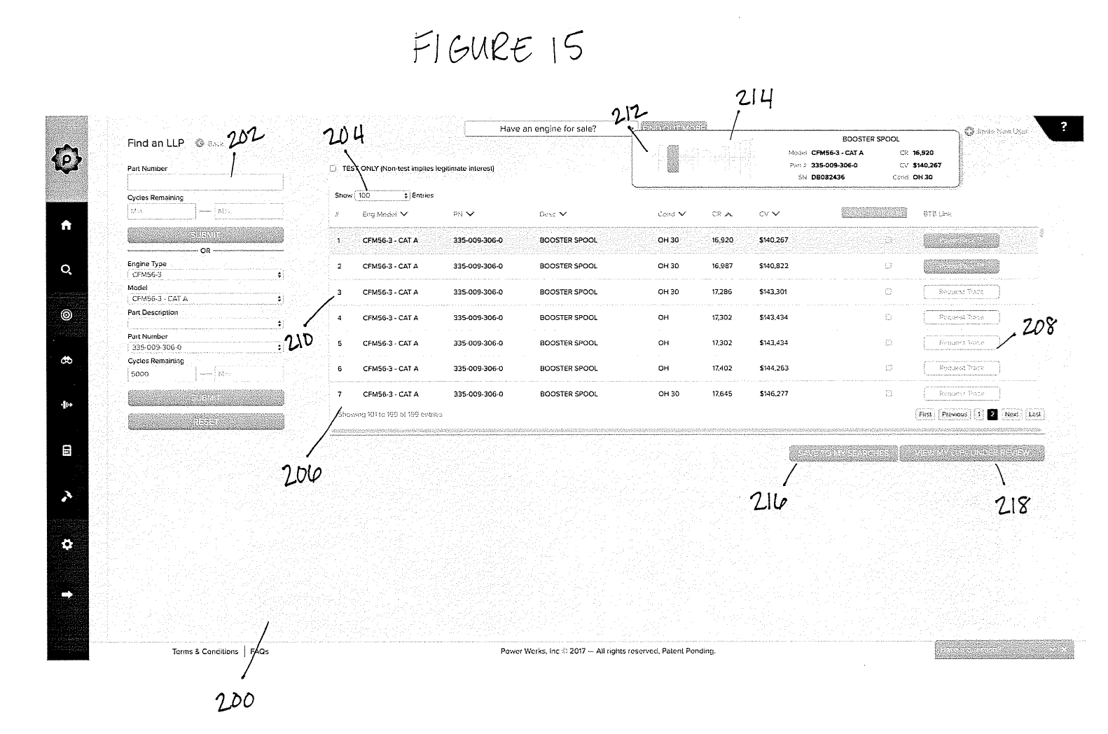

Another embodiment of the review program is shown beginning at FIG. 15. This embodiment shares many features with the embodiment described above. Features which are the same or similar may not be described to avoid undue repetition.

In FIG. 15 is shown a screen 200 that shows to the left a listing of search entry fields 202. The search entry fields permit the user to search for a part by part number and by number of cycles remaining on the parts limited life or to search for a part by engine type, model, par description, part number and/or cycles remaining. By searching for a Life Limited Part (LLP), the user may obtain a list of parts that meet the search criteria. Such a parts list 204 is shown in the middle and extending to the right in FIG. 15. A user looking for a particular part for servicing or rebuilding an aircraft engine is provided with a list 204 of the corresponding parts that are available. Not only are the parts listed, but each part listing 206 is provided with information such as the engine model, the part number, the description, the condition of the part (shown as OH or OH30 in the example), the CR (shown in ascending number value), the CV (shown as a dollar value). Also provided in each parts listing 206 is a check box by which the user may select that part to be reviewed. Another feature for each listing 206 is an identification 208 of the BTB link that indicates if the part has a BTB trace or a PowerPack™ trace bundle. The PowerPack™ trace includes a document bundle that has been enhanced for use by the review program, as described herein.

The user has selected one entry 210 of the list 204. The selected entry 210 has the enhanced document bundle. An information window 212 opens as a result of the selection of the list entry 210, the information window 212 provides information on the selected part and may include an image 214 to indicate the location of the part in the aircraft engine. An outline of the engine's rotating parts is shown in the example. The screen 200 includes a button 216 by which the user may save the search. The screen 200 also includes a button 218 by which the user may view the parts that are under review. For example, if a user is selecting parts to build an engine of parts that have, for example, at least 8,000 cycles left in their limited life, the user may use the button 218 to determine which parts are being reviewed for purchase and which are left to obtain.

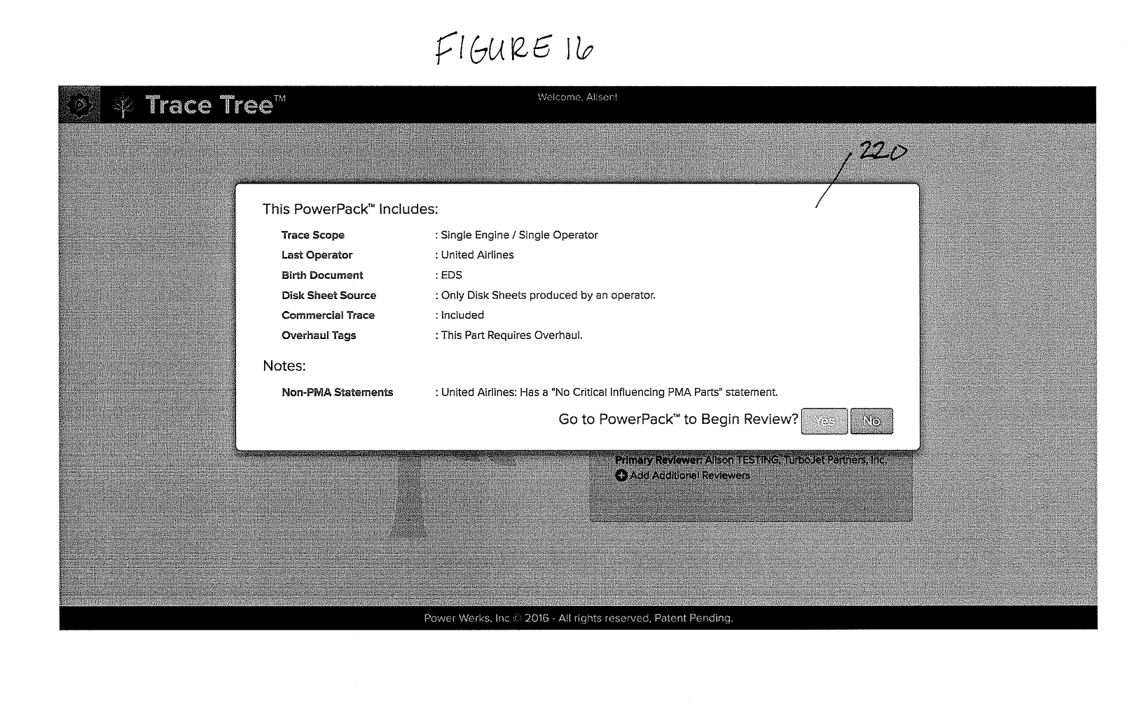

In FIG. 16 is shown a dialog box 220 that is displayed following selection of a part by the user. The dialog box 220 provides a summary of the contents of the document bundle to be reviewed and asks the user if they wish to proceed. The dialog box 220 is similar to that shown in FIG. 1.

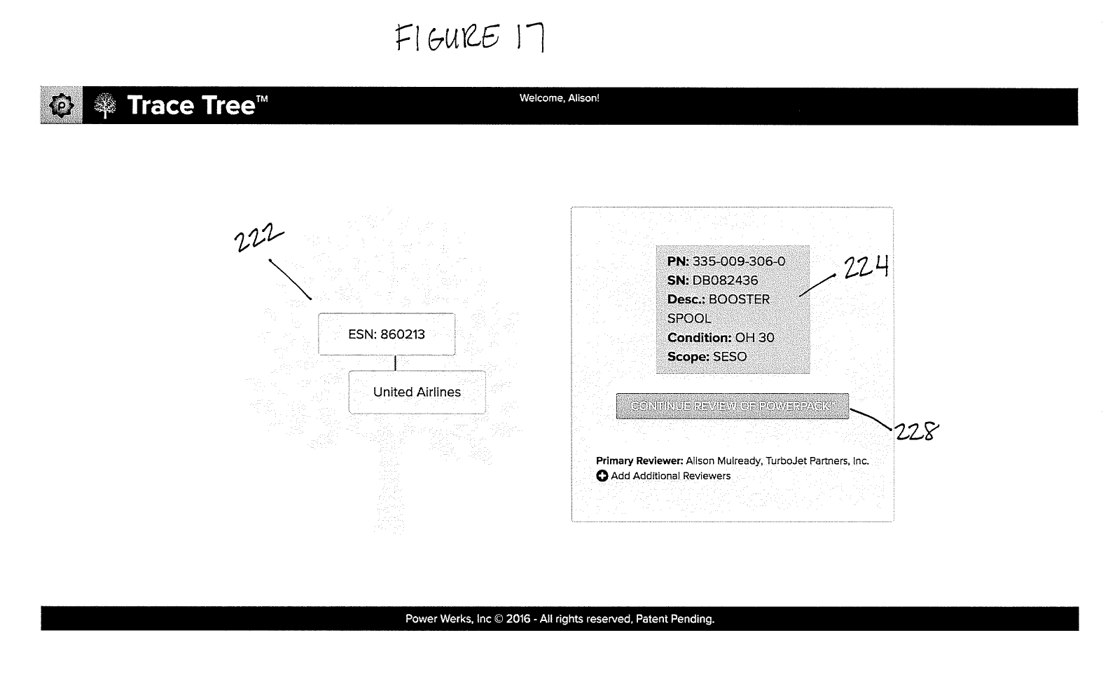

FIG. 17 shows a graphic 222 depicting a Trace Tree document bundle relating to an aircraft part identified by ESN and by operator airline. A shaded box 224 shows the part number, the serial number, the part description (here a booster spool), the condition, and the scope (here SESO). The primary reviewer is named and a symbol 226 may be selected by the user to added additional reviewers. A button 228 may be selected by the user to continue to the review of the document bundle.

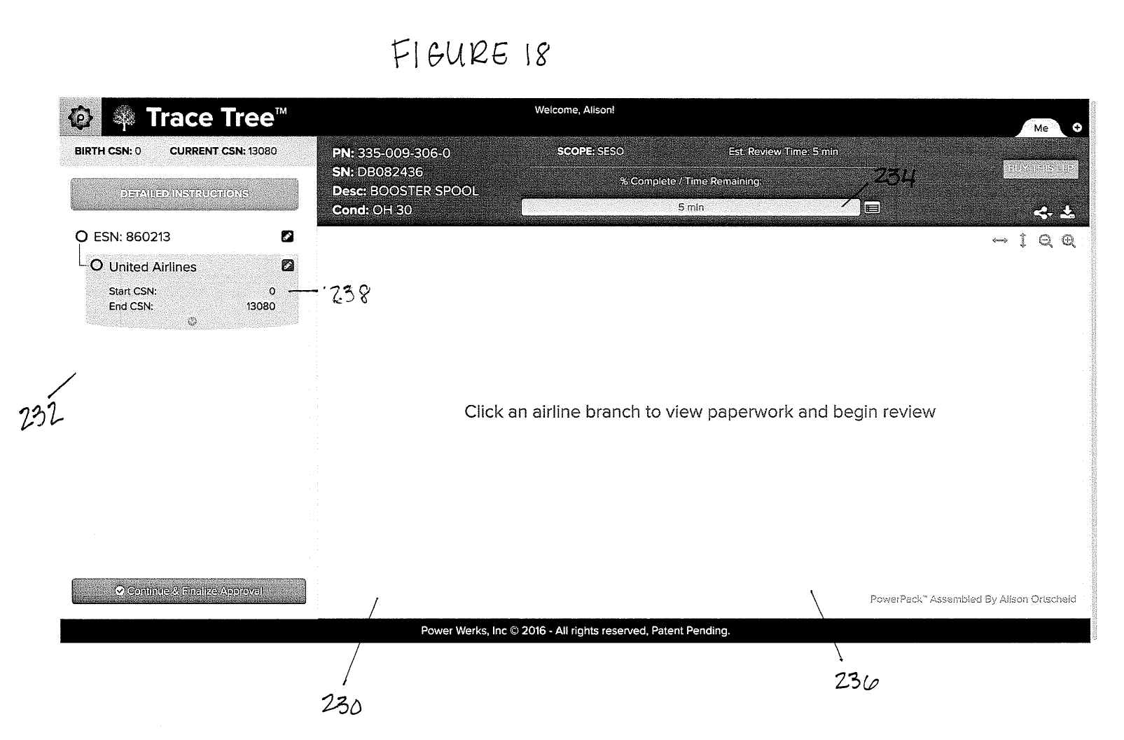

FIG. 18 shows a screen 230 like that shown in FIG. 3, including a column 232 that shows an outline of the significant documents in the document bundle, a progress bar 234, and a document view window 236. The document bundle loaded into the review program relates to a booster spool used by United Airlines as indicated in shaded box 238, in this example.

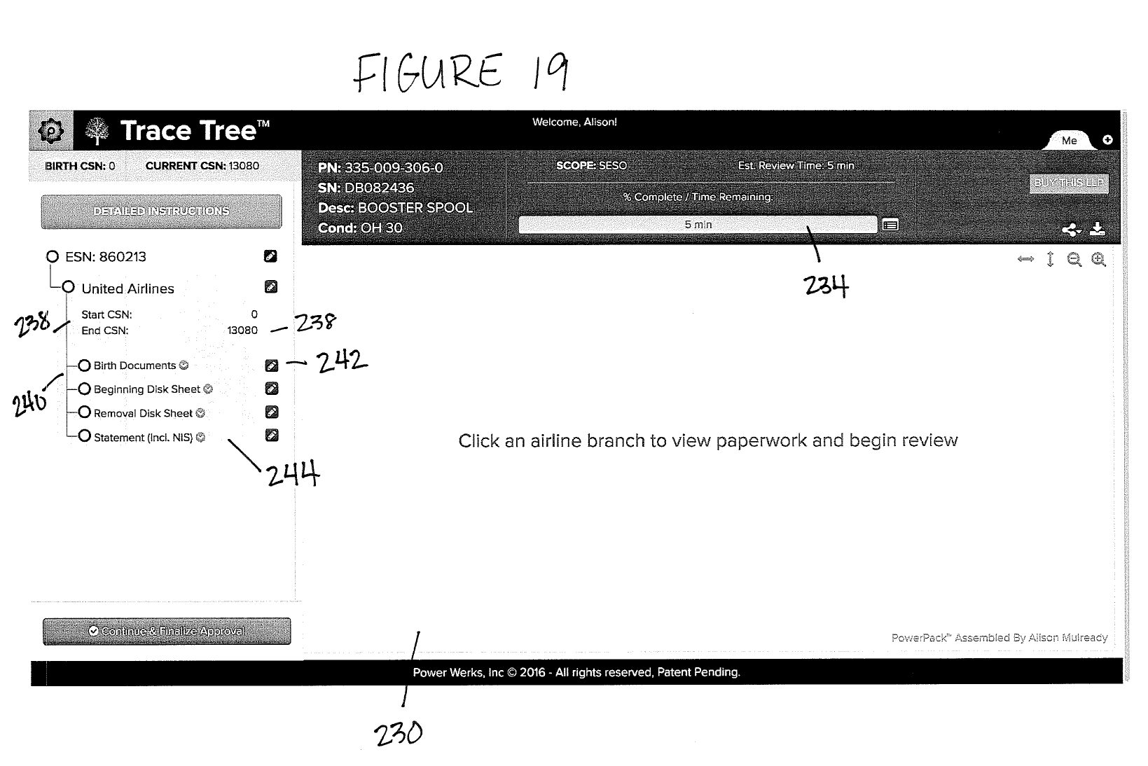

In FIG. 19, the user has expanded the shaded box 238 to show in a branching tree or outline format that the document bundle includes birth documents, a removal disk sheet, and a statement. Adjacent each entry is a circle or other symbol 240 that may be changed to indicate that the corresponding class of documents has been reviewed. As described above, a notes symbol 242 by which the user may enter or read notes relating to the document. Also provided is an expansion symbol 244 that indicates that further information is available under the classification by expanding the corresponding entry in the tree or outline.

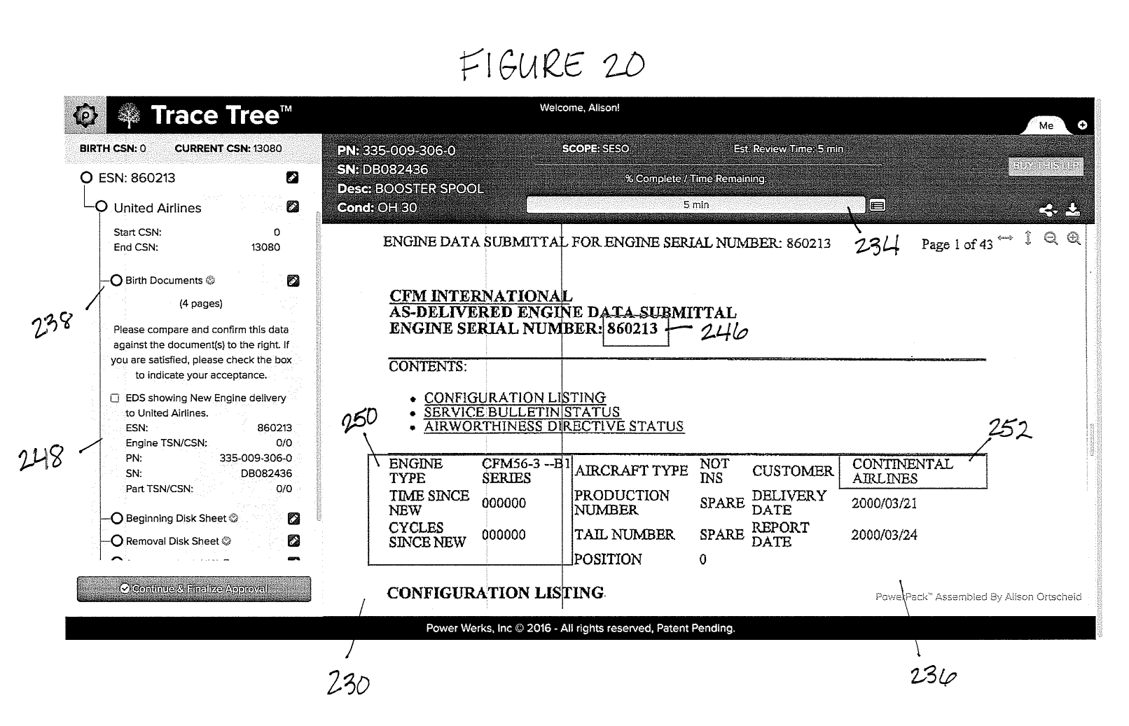

FIG. 20 shows the screen 230 after the user has selected the birth documents category for review. In this example, the birth documents include four pages, as opposed to three pages of birth documents in the example of FIG. 6. The shaded box 238 indicates that the birth documents include an EDS (engine data submittal) for the engine identified by a serial number that has been highlighted by highlight box 246 in the document view window 236. The engine serial number appears several times in the displayed document, which can be compared to the information displayed in the expanded view at 248 in the shaded box 238. A highlight box 250 is also provided around information relating to the engine type and the time since new and cycles since new information. The expanded information 248 shows that the new engine was delivered to United Airlines but the birth document shows the customer for the engine is Continental Airlines, as indicated by the highlight box 252. The user may which to investigate this difference further prior to approving the purchase of the part. Other documents in the document bundle may explain the discrepancy. The progress bar 234 shows that the user has just begun the review.

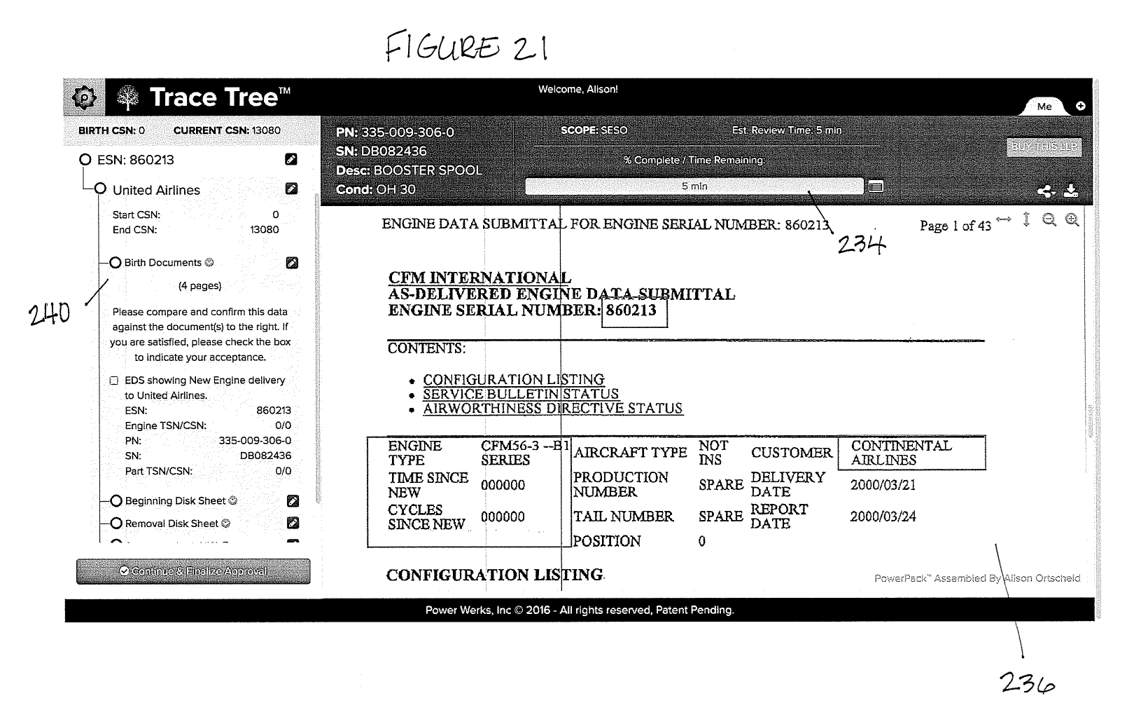

FIG. 21 shows that the user is satisfied with the birth documents and has marked the symbol 240 with a check mark. The progress bar 234 updates to show that the user has made progress in the document bundle review. The displayed birth document shows that it is page 1 of 43 pages. The review program speeds the review by the user by identifying the category of documents to permit direct access to each category and by highlighting significant information in the documents so that the user may easily locate the information. The review program may open the documents of a class by displaying first the portions of the documents having the information of interest. For example, if the 43 page birth document had the information on the part on page 40, the program may first display page 40 upon opening the birth document, or may be operable to move to page 40 without the user paging through the intervening pages. Of course, this is but one example of a document bundle that may be reviewed by the program.

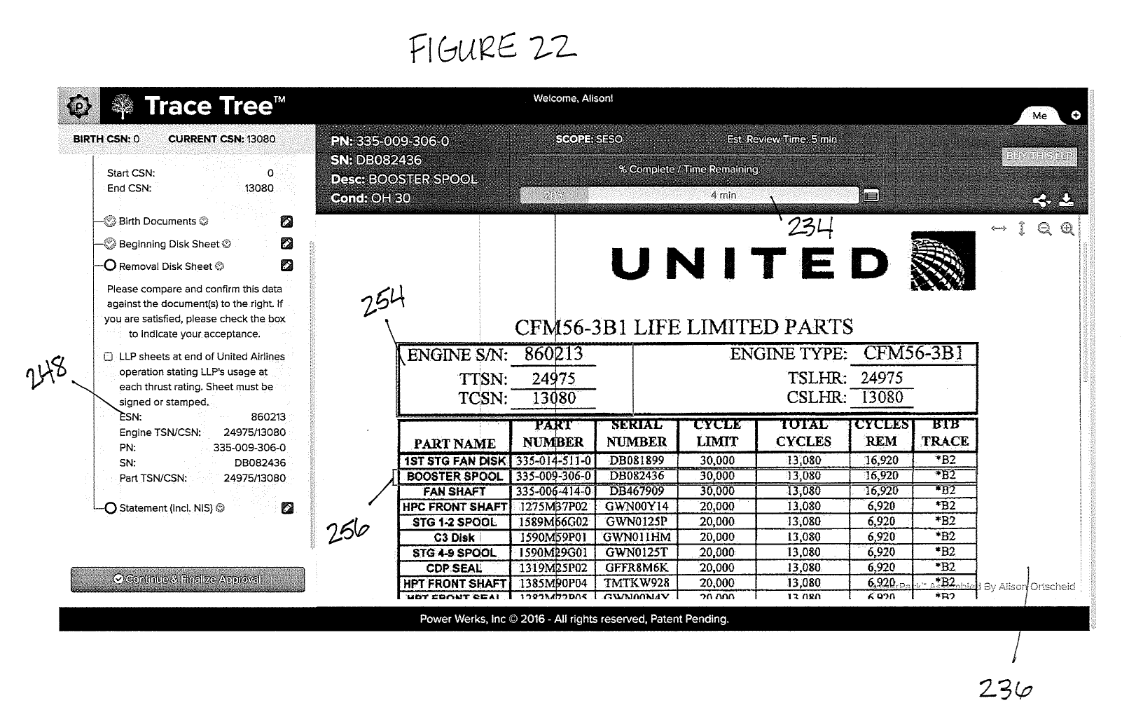

FIG. 22 shows that the review program has displayed the next category of documents, here the removal disk sheet is being viewed. Expanded information 248 is shown for the removal sheet disk. On the displayed document shown in the document view window 236 is a highlight box 254 around the engine serial number and cycles since new and time since new information. The parts removed from this engine during the servicing operation are listed on the form and include a booster spool, the part of interest. The booster spool information is emphasized for the user by the highlight box 256. In the example, the booster spool is shown as having a cycle limit of 30,000 takeoff and landing cycles and was removed from the engine after 13,080 cycles. The sheet shows that 16,920 cycles remain in this parts limited lifetime.

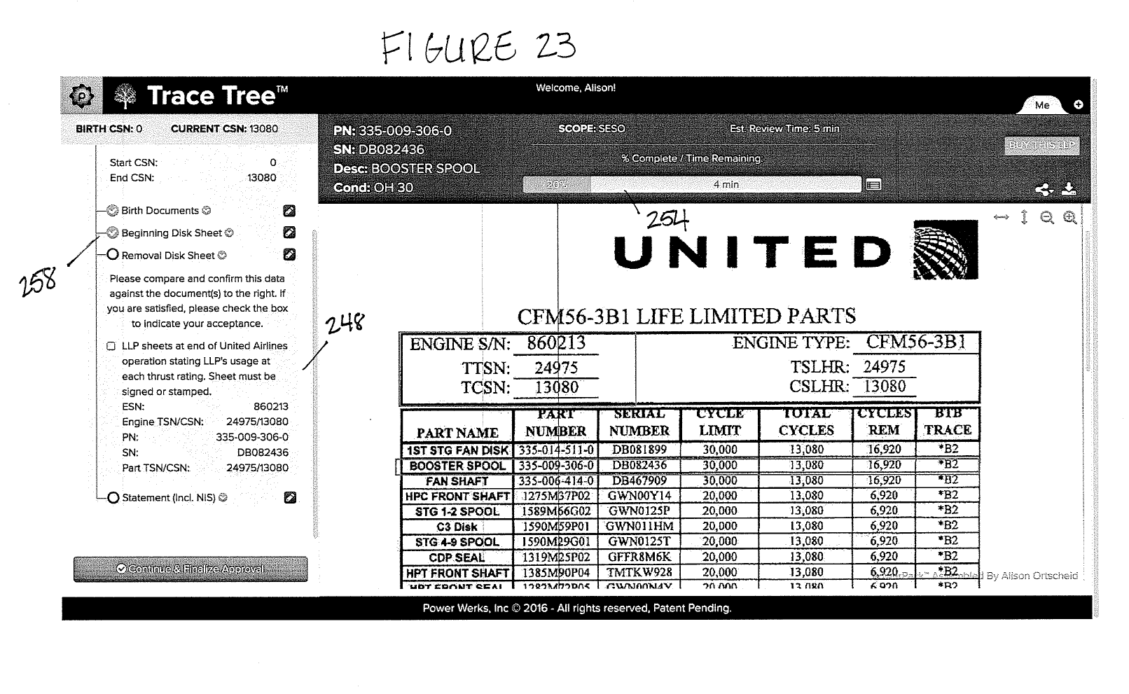

In FIG. 23, the user has marked the symbols 258 with a check mark to indicate approval of the removal disk sheet for this part. The progress bar 234 moves to show the further progress by this user in the document bundle review.

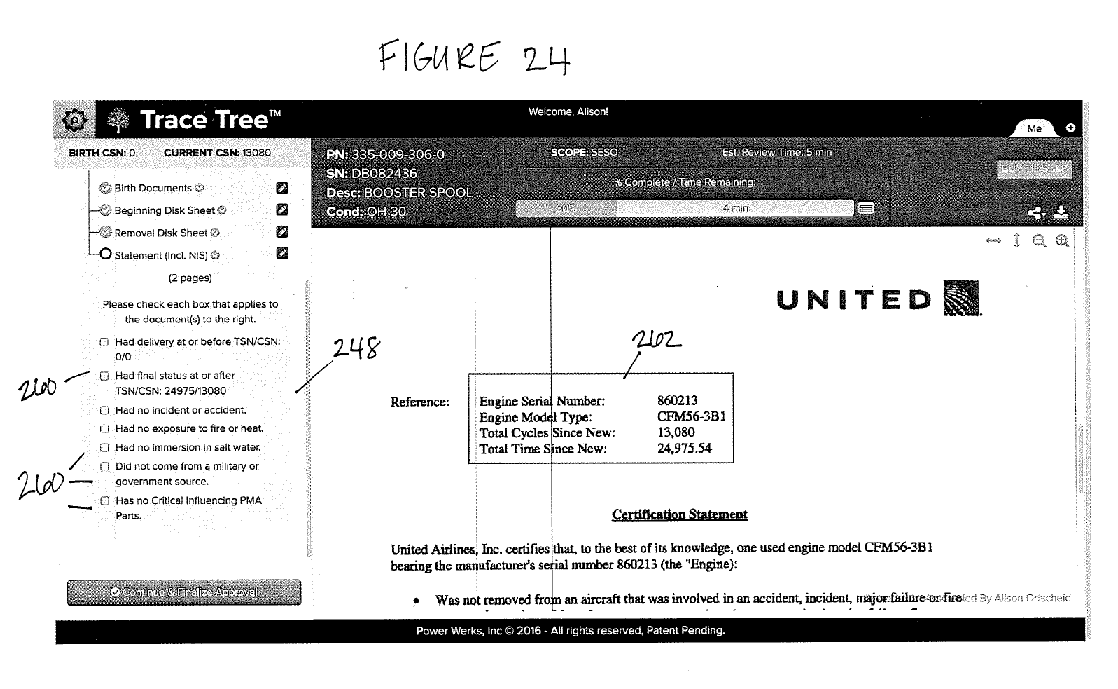

The review program next shows the user documents in the last category, the statement category as shown in FIG. 24. The expanded information 248 indicates to the user that there are two pages in this category. The review program reminds the user of information to be verified in the review and provides a check box 260 for each item. In the example, items to be verified by the user are that the part was not exposed to fire or heat, that it was not in an incident or accident, that it had no immersion in salt water, that it did not come from a military or government source and that it had no PMA parts. The user is also to verify the time and cycles for the part at the delivery of the part and the final status of the part for the operator. The displayed document is marked with a highlight 262 to indicate information on the document that the user may examine in the review.

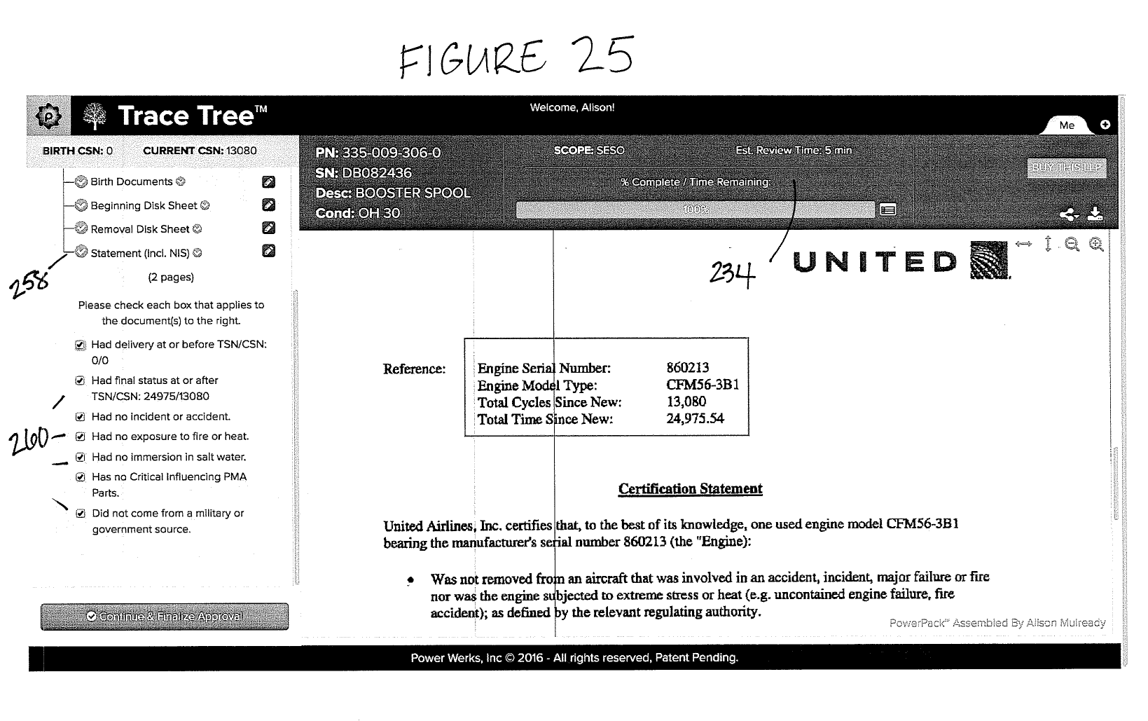

In FIG. 25, the user has checked each of the check boxes 260 to verify the information for each item. The symbol 258 indicates that the statements category has been completed. In this example, this is the last category for review, as a result of which the progress bar 234 shows that the user has completed the document review. Of course, as each increment of the review is completed, the progress bar may move incrementally to show the progress. Other means for indicating progress may be provided instead.

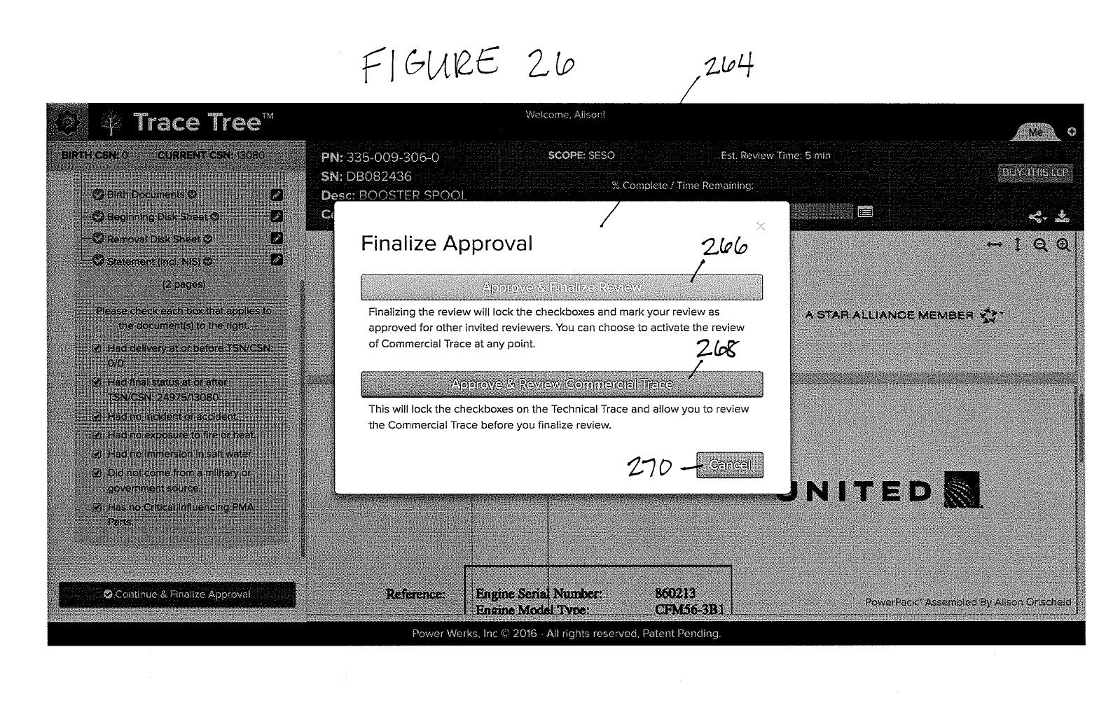

With reference to FIG. 26, the review program now displays a dialog box 264 similar to the dialog box shown in FIG. 9. The dialog box 264 provides the user with the option to approve and finalize the review using button 266. This indicates to other invited reviewers that the review by this reviewer has been completed. The review progress is communicated by the communication component of the program. Another option for the user using button 268 is to approve and finalize the commercial trace. This option locks the check boxes of the technical trace and allows the review of the commercial trace before finalizing the review. A further option by button 270 is to cancel the approval.

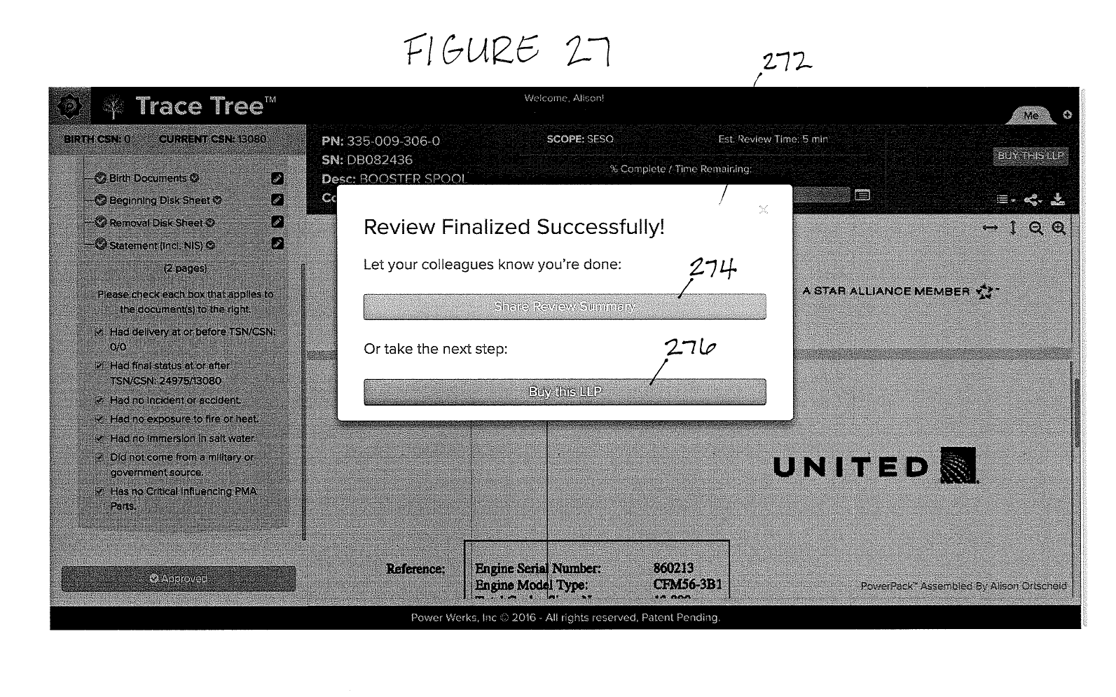

In FIG. 27 the user has finalize the review. A dialog box 272 reports that the review was finalized successfully. The user may select button 274 to share a summary of the review with others or the user may select button 276 to buy the life limited part.

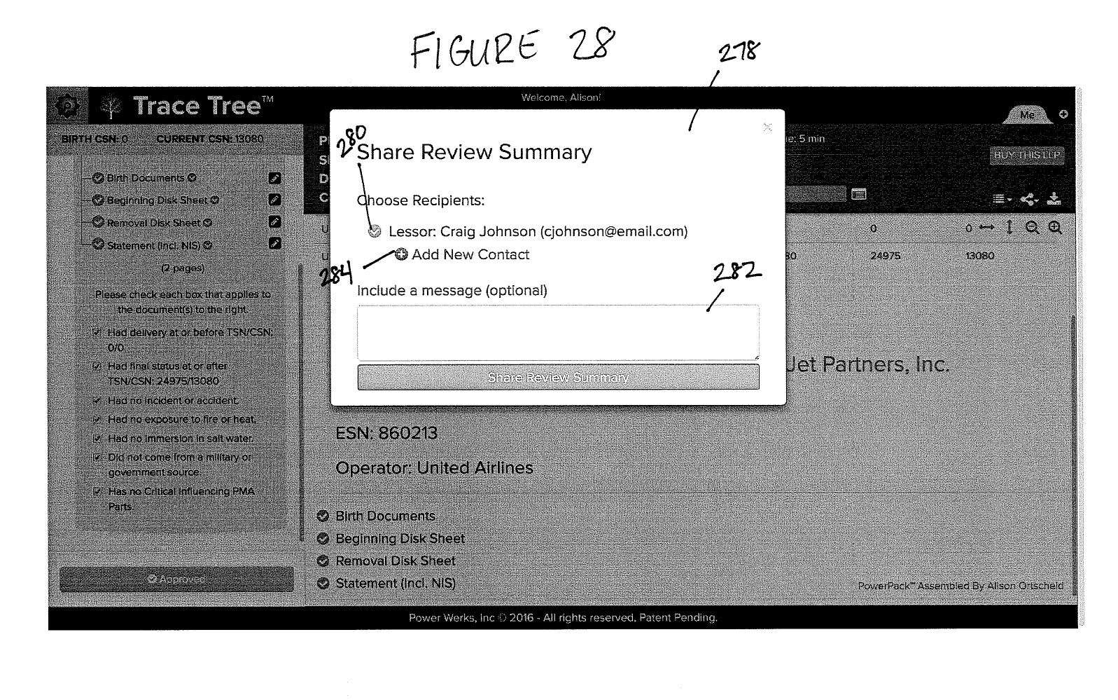

FIG. 28 shows the screen after the user has selected to share the review by button 274. A dialog box 278 indicates the user may share the review with others, add persons to share the review with, and optionally include a message with the review. The recipients to receive the review are marked with a check symbol 280. The message may be added in a message box 282. Recipients may be added by selecting a plus symbol 284.

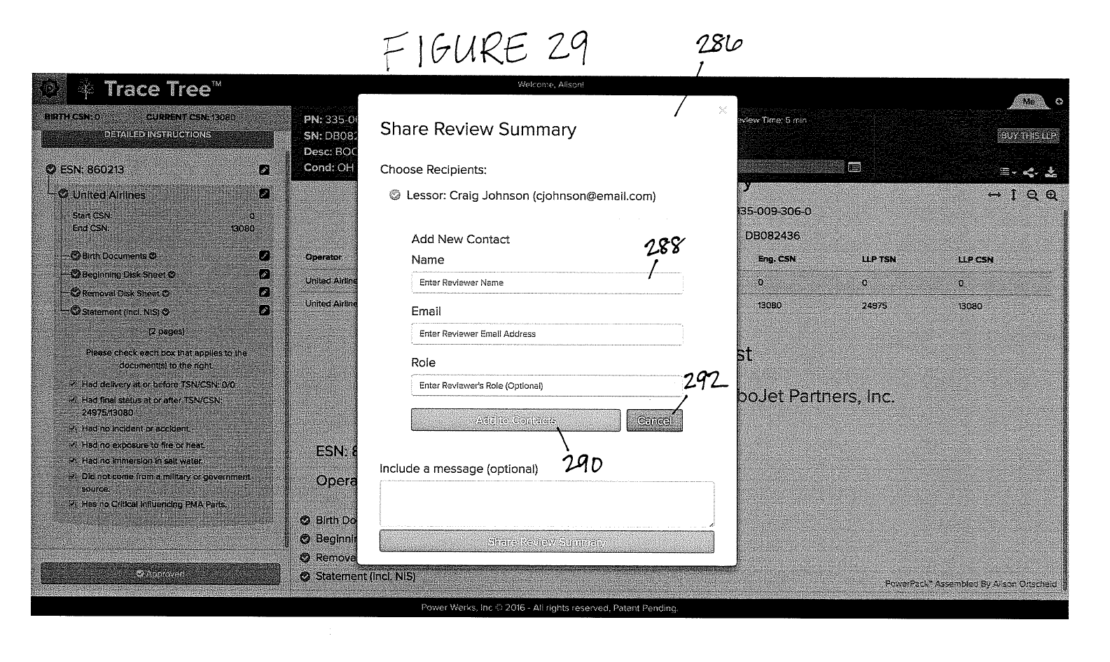

Turning to FIG. 29, the user has selected the symbol 284 to add a new contact. The dialog box 286 is displayed with spaces 288 for entering name, email address, and role. An add contacts button 290 is provided, or a cancel button 292 to cancel adding the new contact.

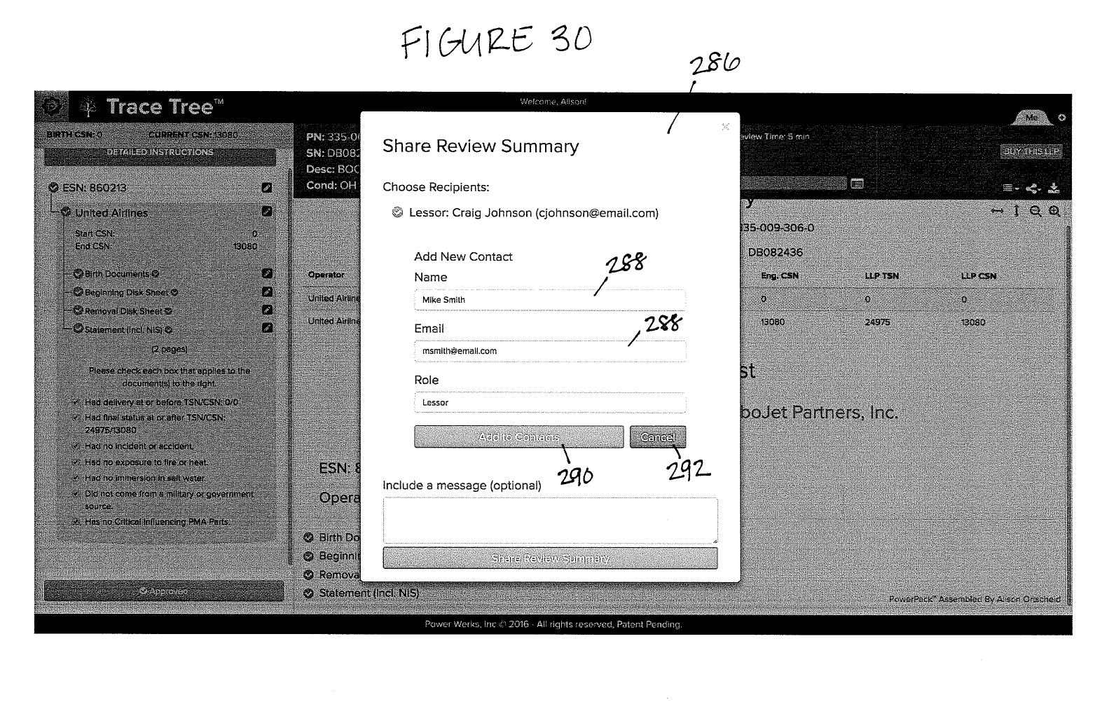

FIG. 30 shows that the user has entered information into the spaces 288. This person will be added to the recipients that will receive the review through the program's communication system.

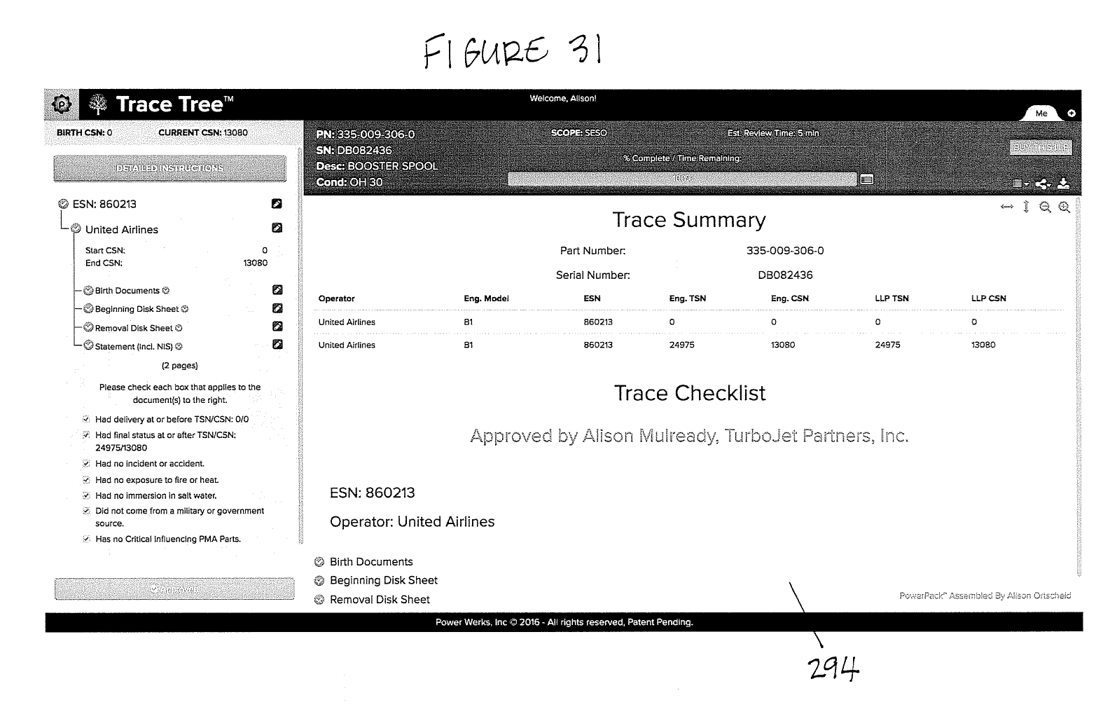

In FIG. 31 a summary of the review or trace and a check list 294 are shown, which is similar to the summary shown in FIG. 10.

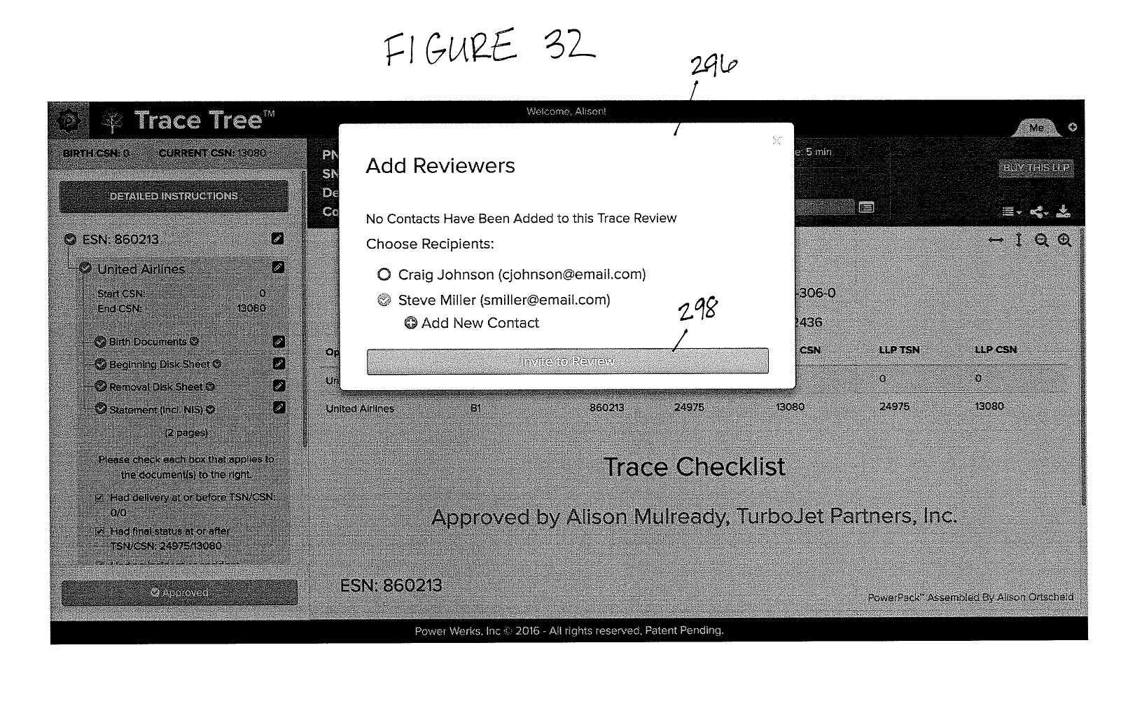

In FIG. 32 is provided a dialog box list 296 of potential reviewers. The user may elect to add further reviewers at this stage by selecting a name from the list or adding a new contact and selecting the invite to review button 298.

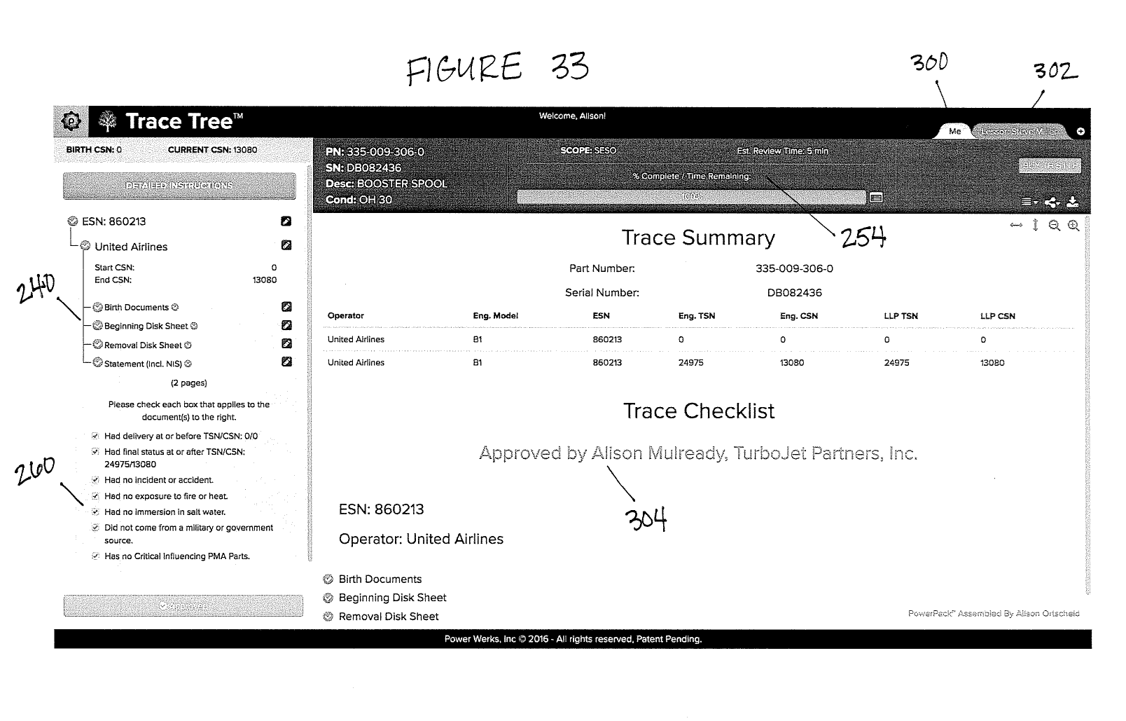

FIG. 33 shows the trace summary and trace checklist for the user, as indicated by the tab 300 in the upper right corner. A further tab 302 is provided for each invited reviewer. The user's tab 300 is selected and the display indicates at 304 that the user has approved the document bundle for the part. All of the check box symbols 240 and 260 are checked and the progress bar 254 indicates that the review was completed.

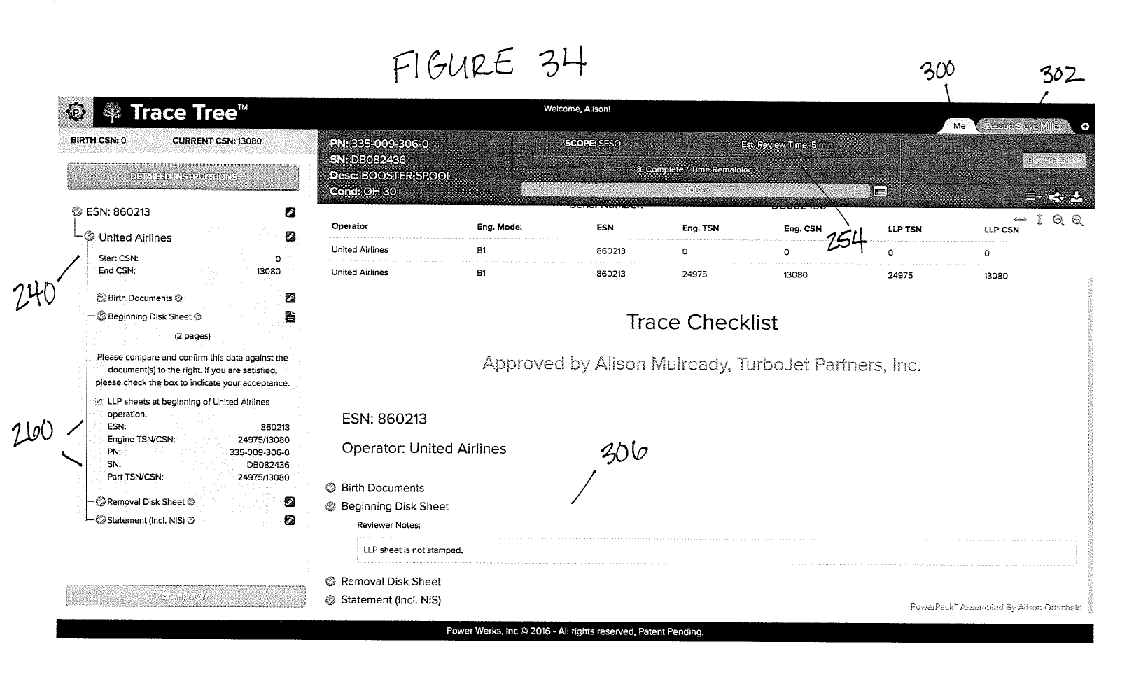

In FIG. 34 is shown the screen when the further tab 302 has been selected. The progress by the other reviewer is shown to the user. The user may determine that the other reviewer has completed the review, is in process, or has not yet begun. In the illustration, the other reviewer has not yet begun the review. None of the boxes 240 and 260 are checked and the progress bar 254 shows that no progress has yet been made. Also in this example, the trace checklist includes a list 306 of issues for the further reviewer to consider. Some of these issues 306 may be notes by the initial reviewer or may be provided by the review program or from another source.

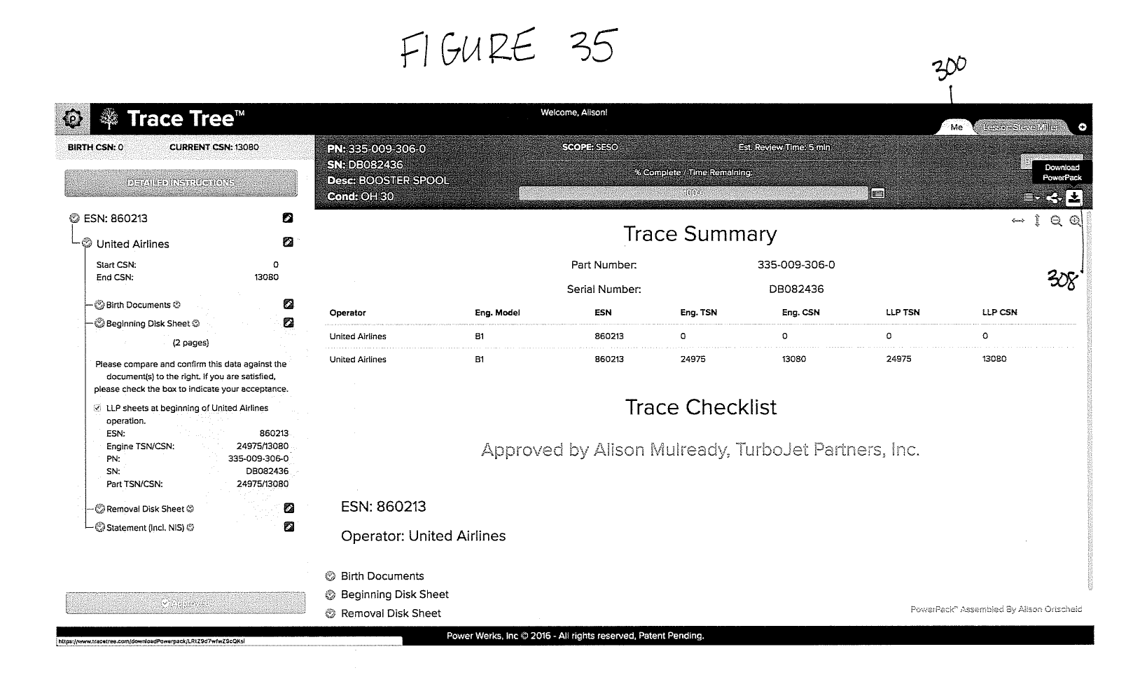

FIG. 35 shows the summary when the user's tab 300 is selected. The user may select a download button 308 by which the document bundle may be downloaded. In this example, the document bundle is a PowerPack™ document bundle.

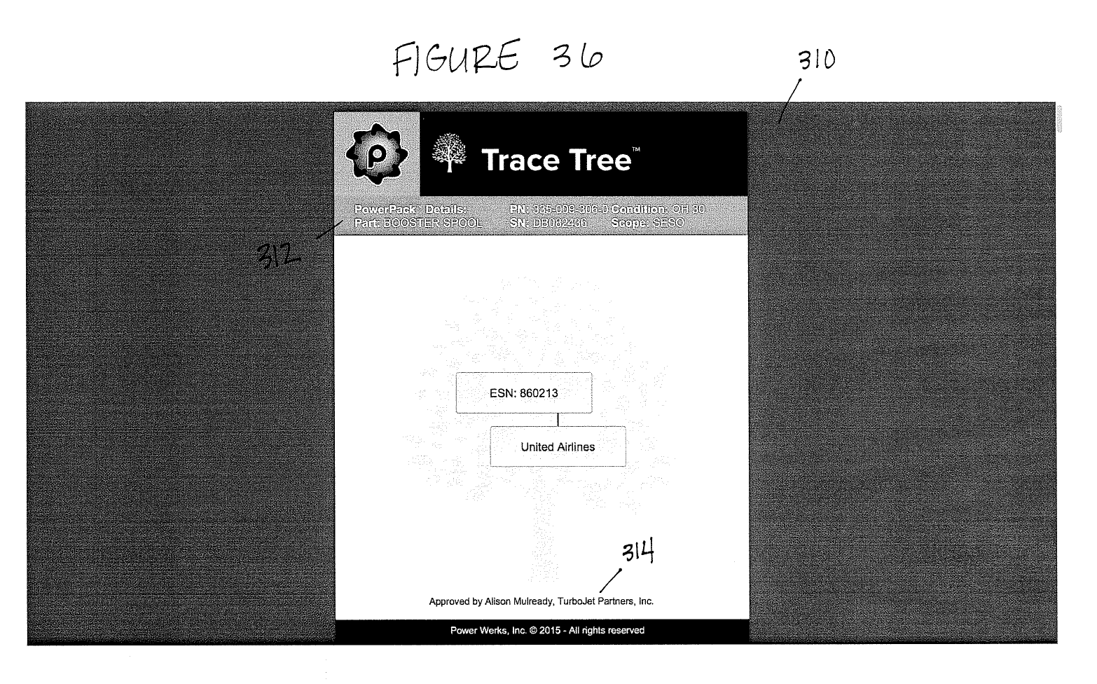

FIG. 36 shows the closing screen 310 for the document review program of a certain example. The details relating to the part are shown in a band 312. The approval by the user is indicated at 314.

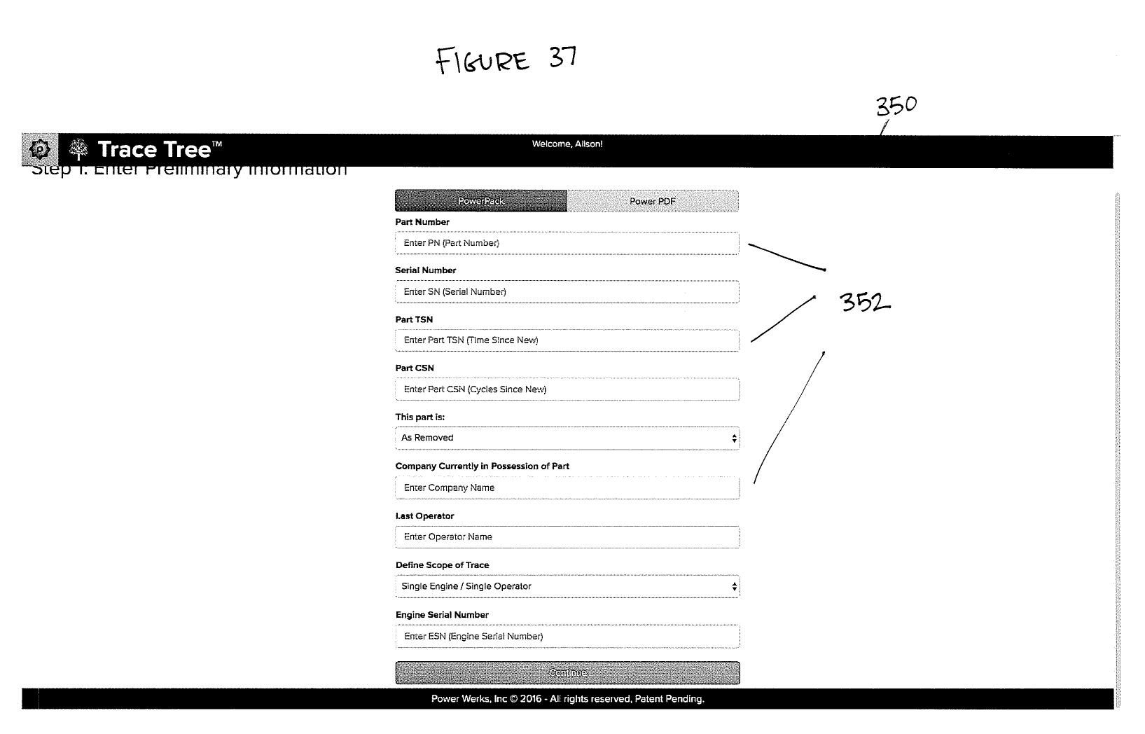

Document bundles for review in the review program may come from a variety of different sources and may be formatted and configured in a variety of ways. In certain embodiments, the document bundle is processed prior to use in the review program. An example of a document bundle processing program, referred to as a Trace Genie, is shown beginning at FIG. 37. In some examples, all document bundles to be reviewed in the review program are created in the document bundle processing program prior to review.

In FIG. 37, a screen 350 is provided for the document preparer to enter preliminary information. Text entry boxes 352 are provided for the preparer to enter a part number, a serial number, a time since new (TSN) and a cycles since new (CSN) for the part. Further information includes condition of the part, company in possession of the part, the last operator, the scope of the trace and the engine serial number.

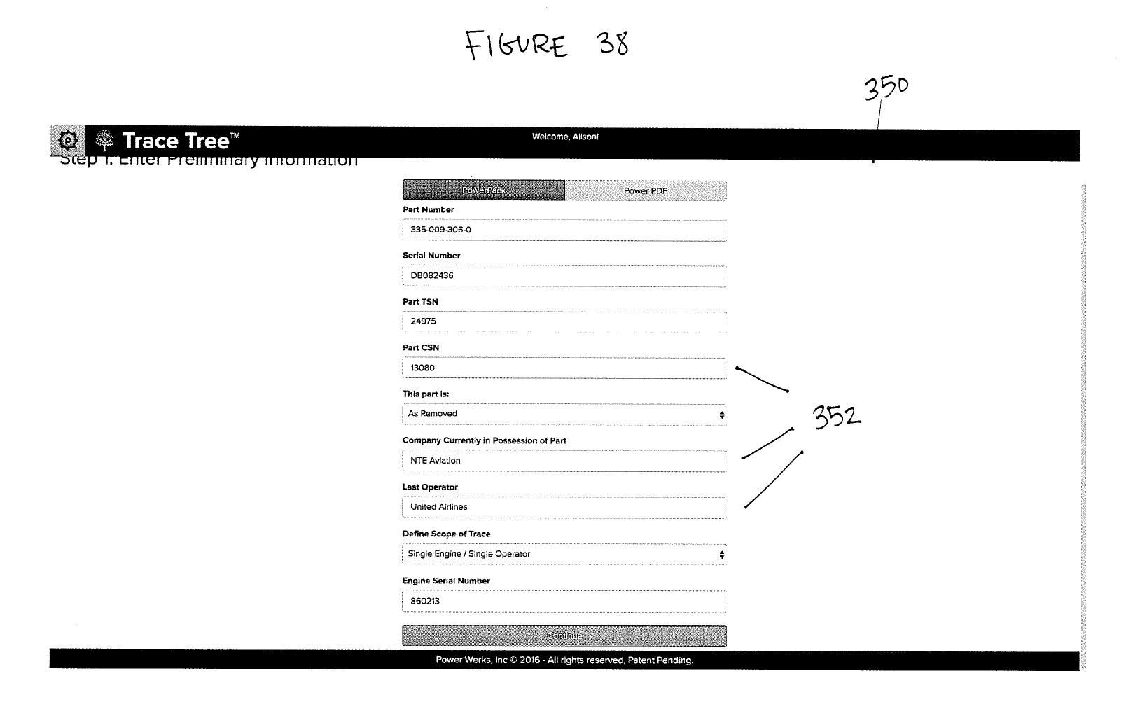

FIG. 38 shows the screen after the preparer has entered the information into the boxes 352. The preparer may obtain this information from the document bundle or from other sources.

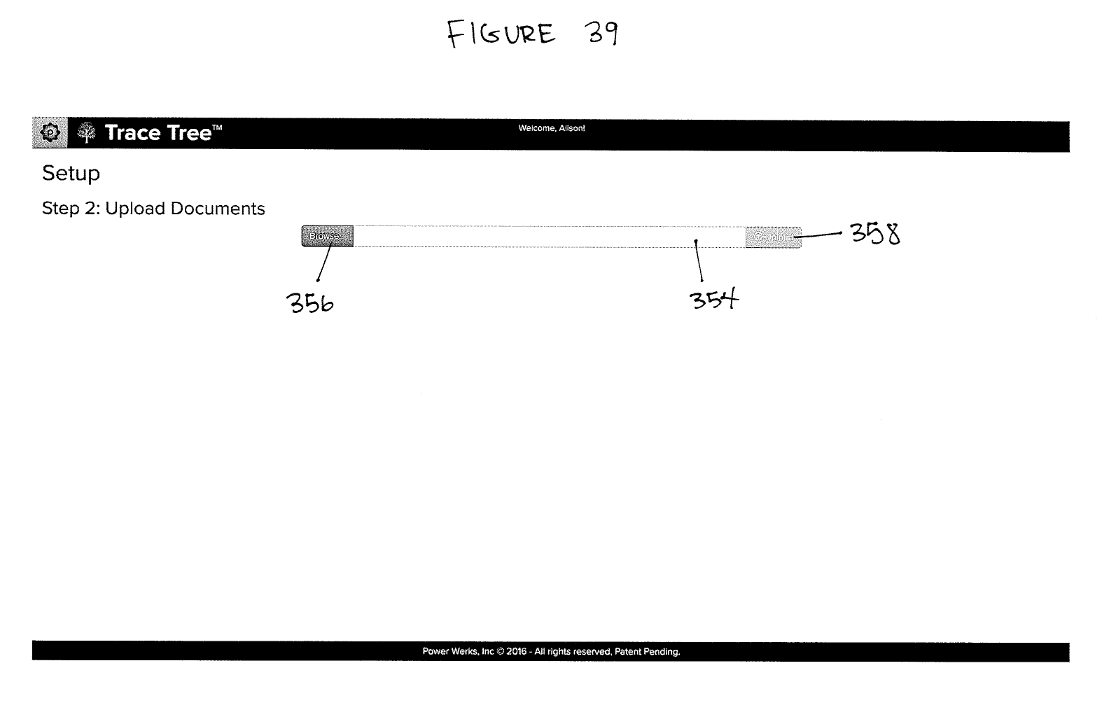

FIG. 39 shows the step of uploading the documents into the preparation program. Here, a box 354 is provided for the preparer to enter the address of the electronic document bundle. A browse button 356 is provided to permit the preparer to point to the document bundle file instead of typing in the address. An upload button 358 is selected once the address is entered so that the electronic document bundle file is uploaded into the processing program. The document bundle may be in any format, including Adobe Acrobat PDF format for example. It is also possible that the document bundle may be physical paper copies, which are scanned and uploaded as electronic files.

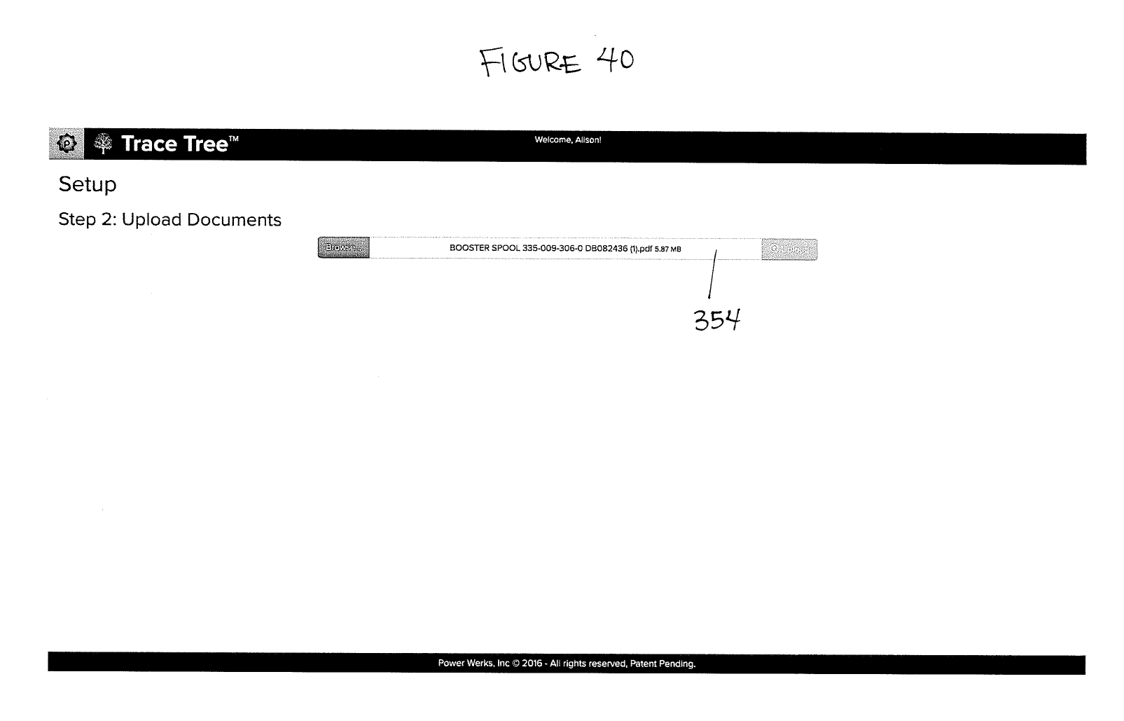

In FIG. 40 the preparer has entered the file name and address of a document bundle for a booster spool into the address line 354.

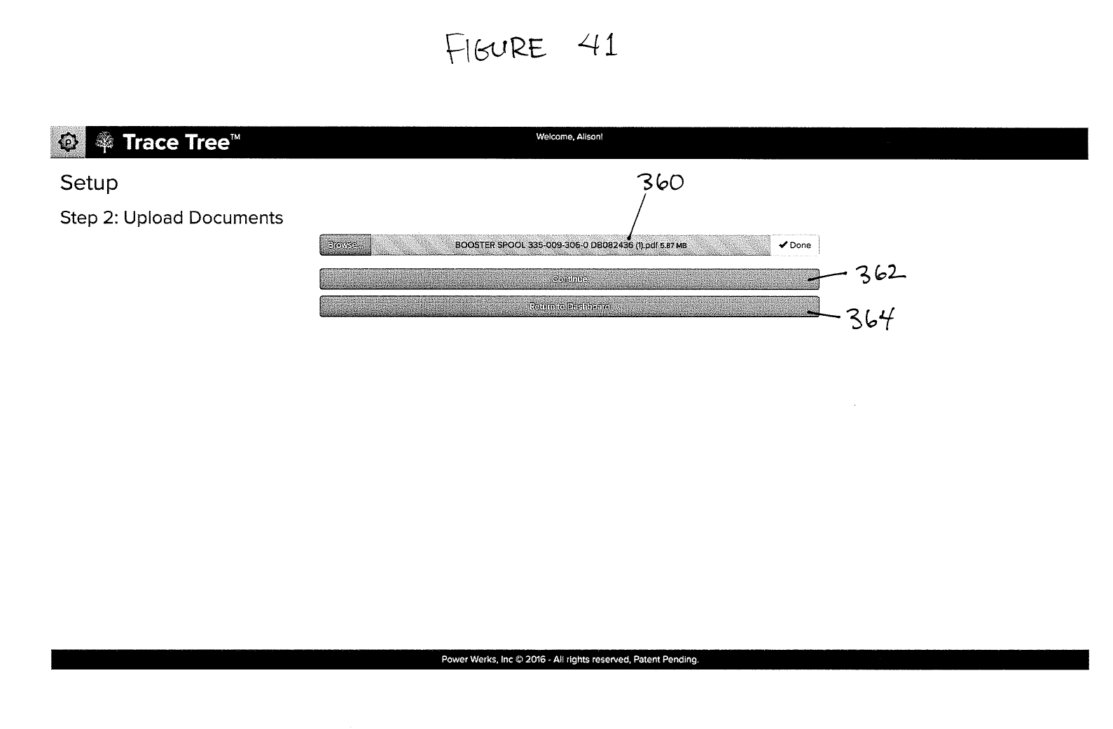

FIG. 41 shows that the electronic document bundle has been uploaded, as indicated by a progress bar 360. The upload button 358 indicates “done.” The preparer is provided the options of Continue at 362 or return to dashboard at 364. The documents are converted to individual images for each page. For example, a thirty page document is converted to thirty individual documents, one for each page.

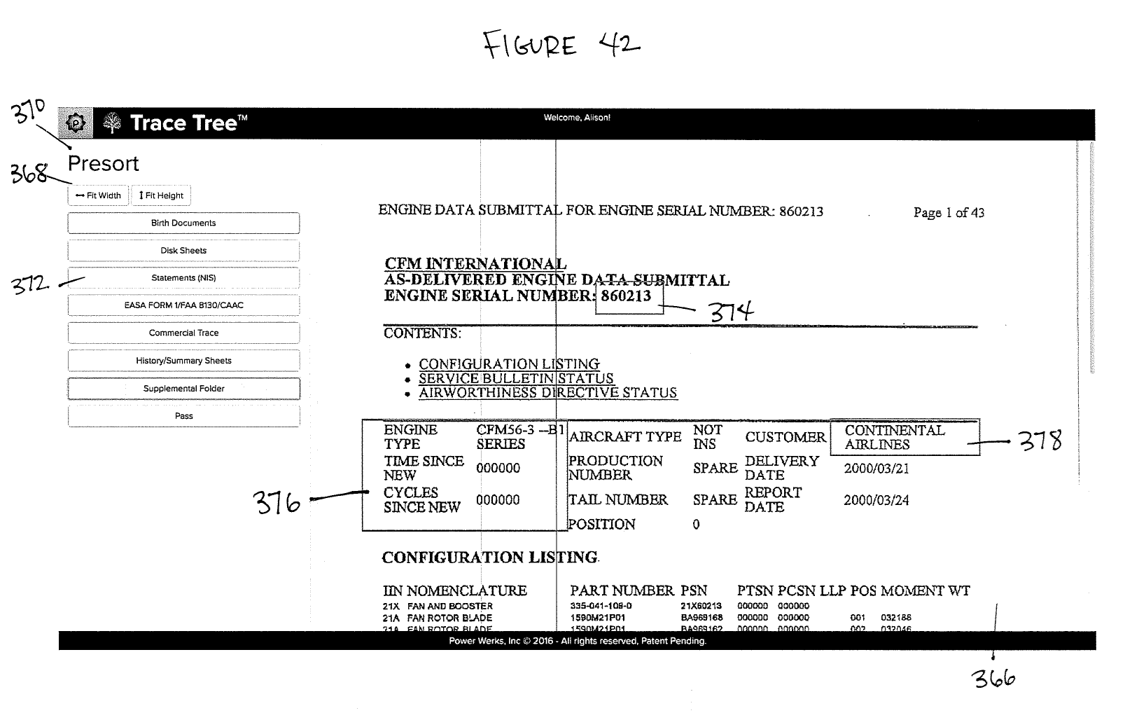

Once the document bundle has been uploaded into the preparation program, the documents are shown to the preparer in a document view window 366 of FIG. 42. The preparer is provided with sizing tools 368 in a presort column 370. The presort column asks the user to select from document categories shown as buttons 372. The preparer may select a button 372 as a birth document, disk sheet, statements, EASA form, a commercial trace, a history or summary sheet. Each document is categorized. The preparer may also select supplemental folder. If the preparer is unable to determine the category of the document, they may select the pass button. This process is completed for each document in the document bundle or pack. In the illustrated example, the preparer has determined that the displayed document is a birth document relating to the “birth” of the part, or initial use of the part. The preparer has highlighted areas 374, 376 and 378 as showing information that may be relevant to a reviewer when reviewing the document. In the example, this includes engine serial number, engine type, time and cycles since new, and the operator of the engine in which the part was used.

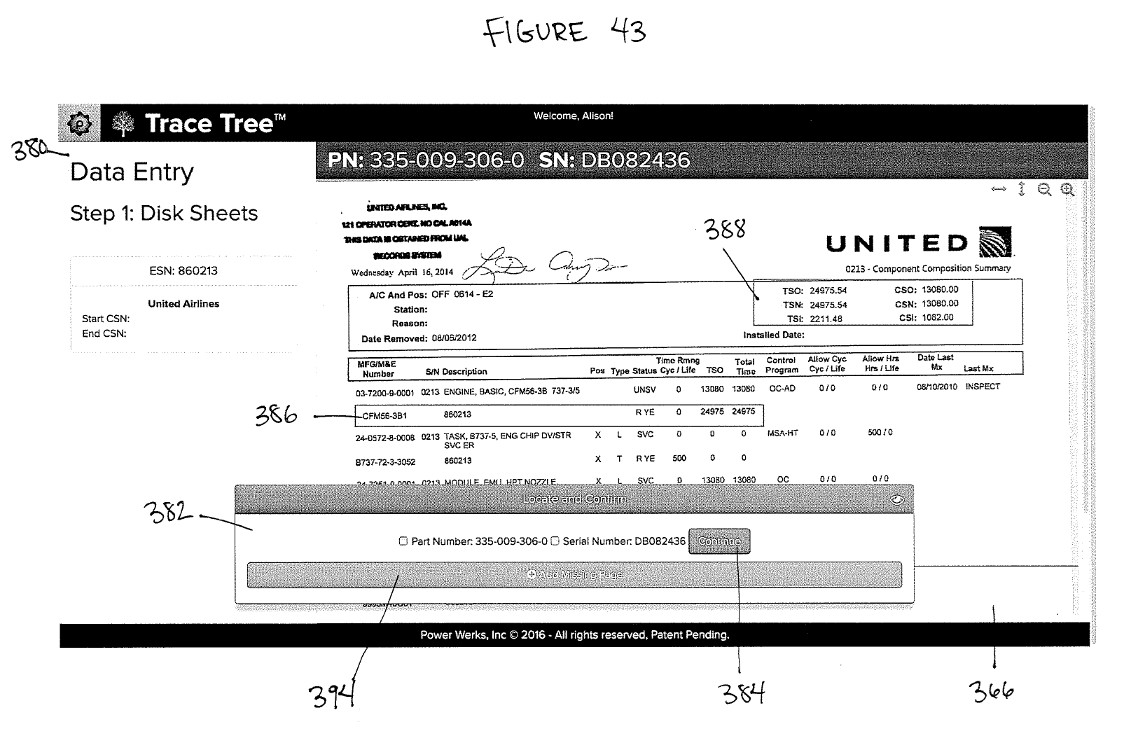

After completing a document, the preparer moves to another document, as shown in the document viewer 366 of FIG. 43. The preparer has identified the document as a disk sheet, which results in the preparation program showing steps relating to this category of documents in the data entry column 380. A dialog box 382 is displayed. It asks the preparer to locate and confirm the part number and the serial number of the part. Once those numbers are located and confirmed by the preparer, the continue button 384 may be pressed. In this example, the preparer has highlighted information on the document at highlights 386 and 388.

The preparation program guides the preparer through the preparation process without the need for the preparer to understand the history or technology behind the document or the significance of the document to the part or engine. The reviewers who review the documents for approval may be skilled technicians or experienced at some aspect of aircraft operation, maintenance, or other skilled and/or technical fields. The review program ensures that the reviewer notes the details such as part numbers while reviewing the documents with a technical eye. The preparer on the other hand need not have a technical background but need only follow the guide instructions of the document bundle preparation program.

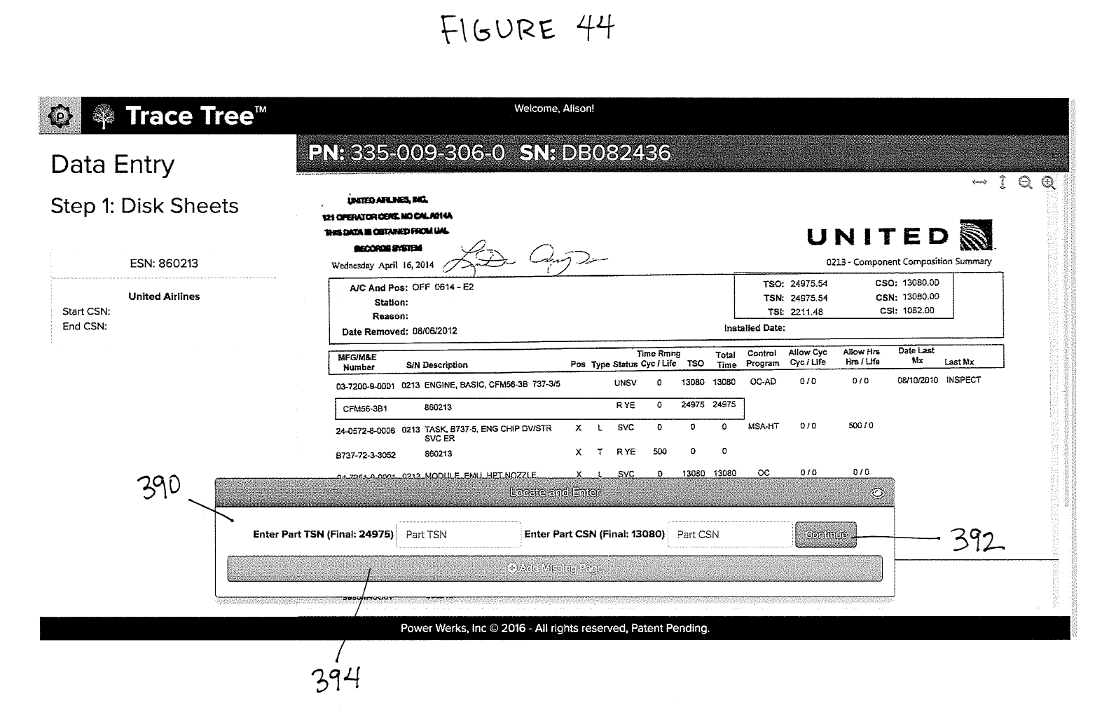

FIG. 44 shows that a dialog box 390 is displayed over the document asking that the preparer enter the TSN (time since new) and CSN (cycles since new) values that are shown on the document. Once entered, a continue button 392 may be pressed. Both dialog boxes 390 and 392 include an add missing page button 394 by which additional pages from the document bundle may be added to the identified category. For example, the requested information for the dialog box may be on other pages in the bundle, which are added to the category using the button 394.

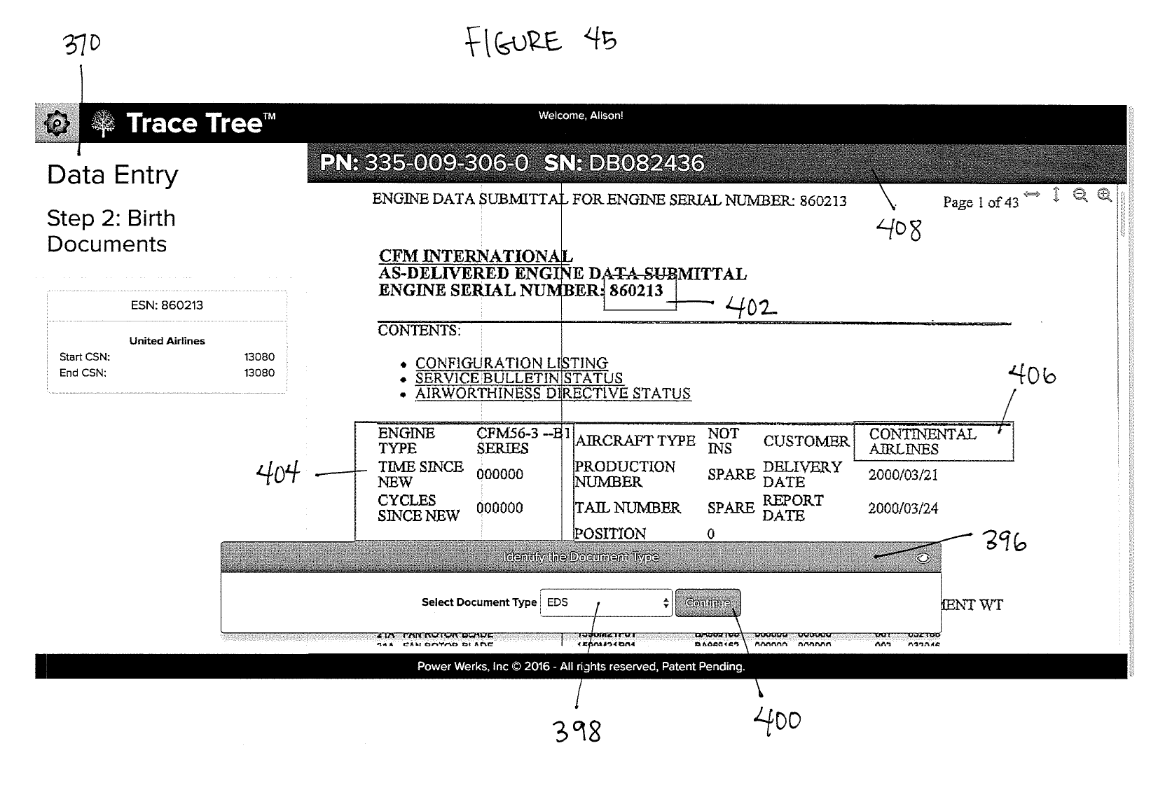

FIG. 45 shows the preparer another document in the bundle and guides the preparer by a dialog box 396 to select a document type of the displayed document. A pull down box 398 includes a list of possible document types from which to choose. Once the correct document type is selected, a continue button 400 may be selected by the preparer. In the example, the displayed document type is an as delivered engine data submittal (EDS) and the preparer has selected EDS as the document type. The preparer may have added the highlights 402, 404, and 406 to the document. A band 408 across the top of the document display portion provides the part number and serial number of the part being considered so that the preparer may easily locate this information on the document. The preparer is reminded of the engine serial number in the column 370.

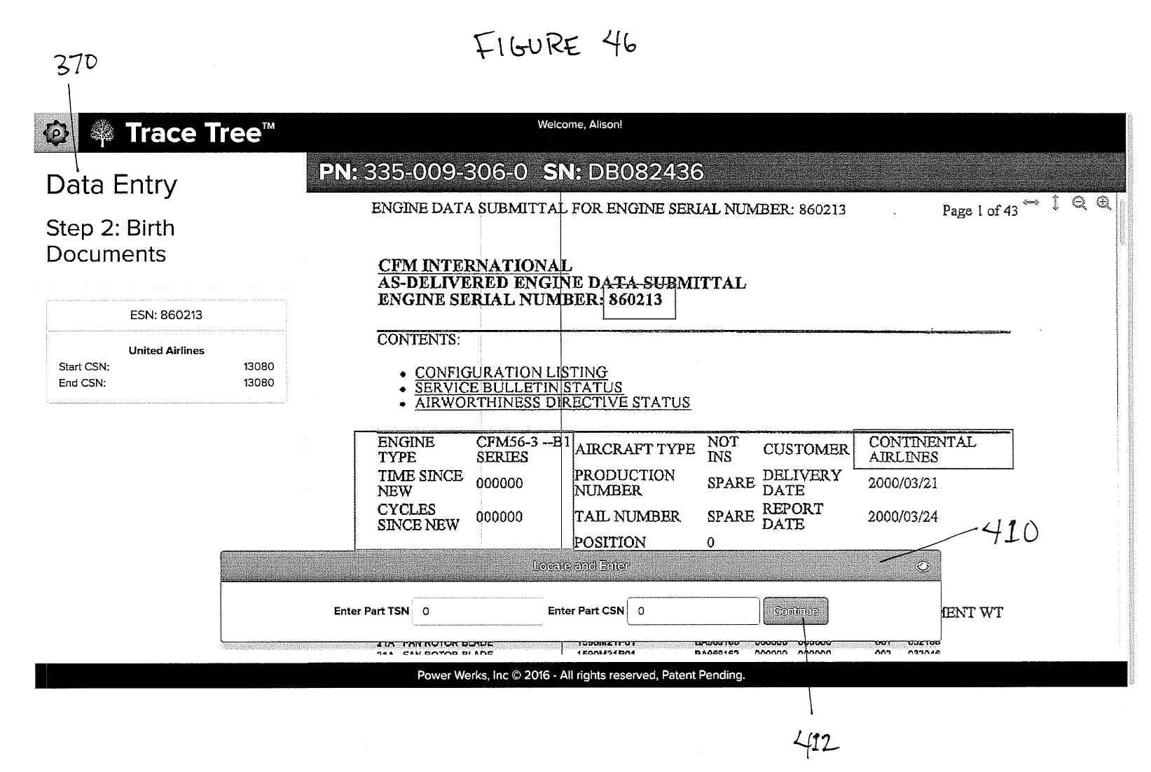

FIG. 46 shows a dialog box 410 that asks the preparer to enter the time since new and cycles since new values from the displayed document. A continue button 412 is selected once the values are entered.

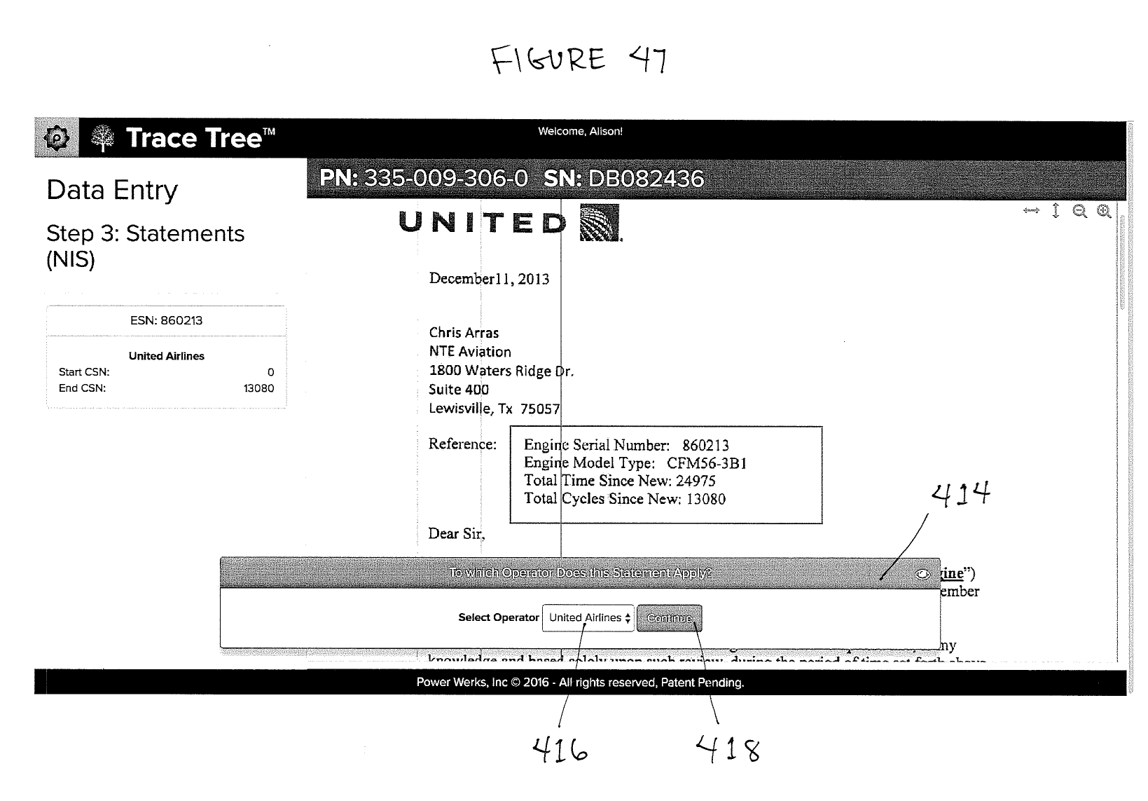

In FIG. 47, in step 3 the preparation program is looking for Statements (NIS) in the document bundle. The preparer may have informed the program that the displayed document is a statement. A document is shown to the preparer and a dialog box 414 asks for the operator to which the statement applies. The operator name is shown at the top of this document, and the corresponding name is selected from a pull down box 416, after which the preparer may confirm at 418. In this way, the information used by the review program is populated into the enhanced document bundle.

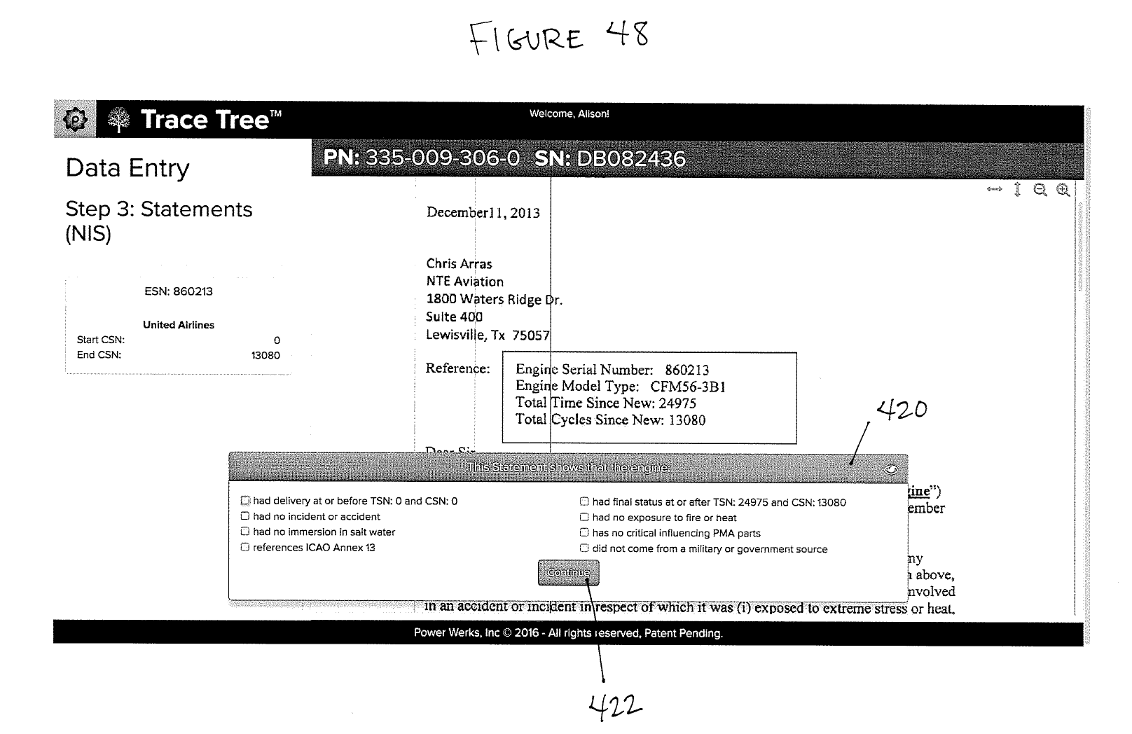

FIG. 48 shows a dialog box 420 by which the preparer may determine whether certain conditions or events are shown in the statement document. In the example, the conditions or events asked of the preparer are: had delivery at or before TSN 0 and CSN 0, had no incident or accident, had no immersion in salt water, references ICAO Annex 13, had final status at or after TSN 24975 and SCN 13080, had no exposure to fire or heat, has no PMA parts, did not come from a military or government source. A continue button 422 is provided once the conditions are selected.

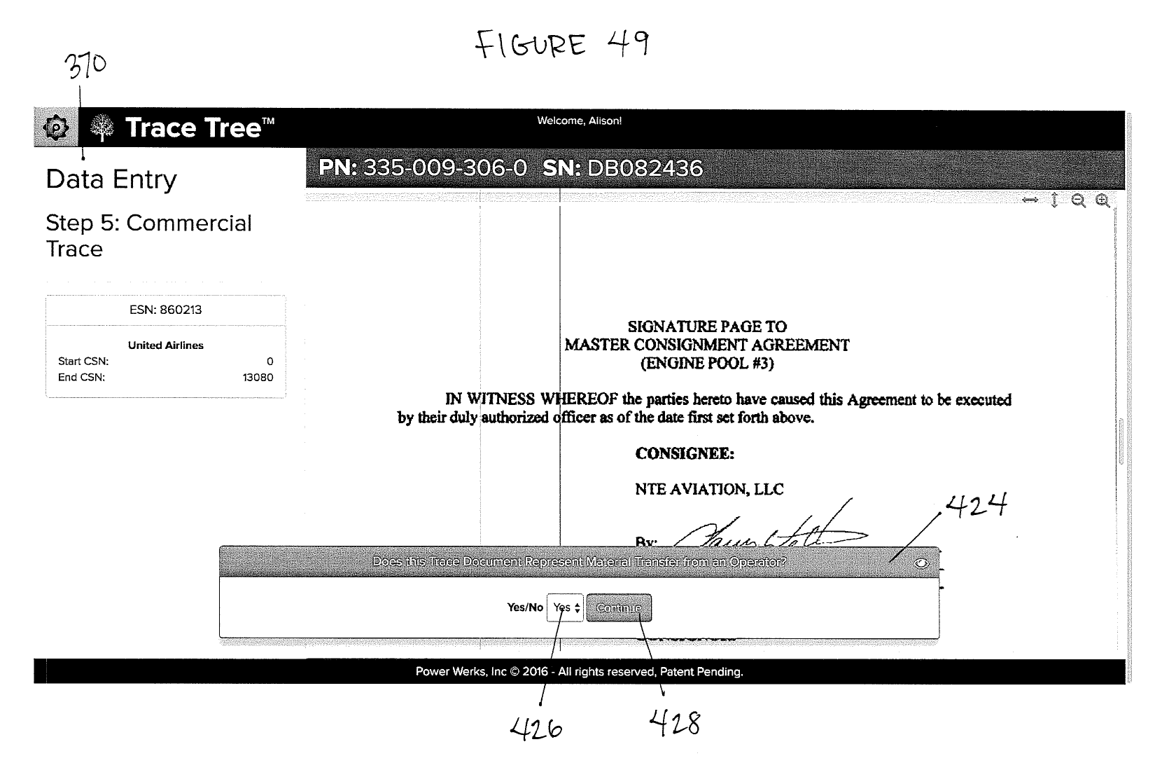

FIG. 49 provides preparer guidance for commercial trace, step 5, as indicated at 370. A dialog box 424 asks the preparer to indicate whether the trace document represents a material transfer from an operator. A pull down box 426 permits the user to select yes or no, and then press box 428 to continue. The displayed document is a consignment agreement showing transfer of an aircraft engine, so the preparer has answered yes.

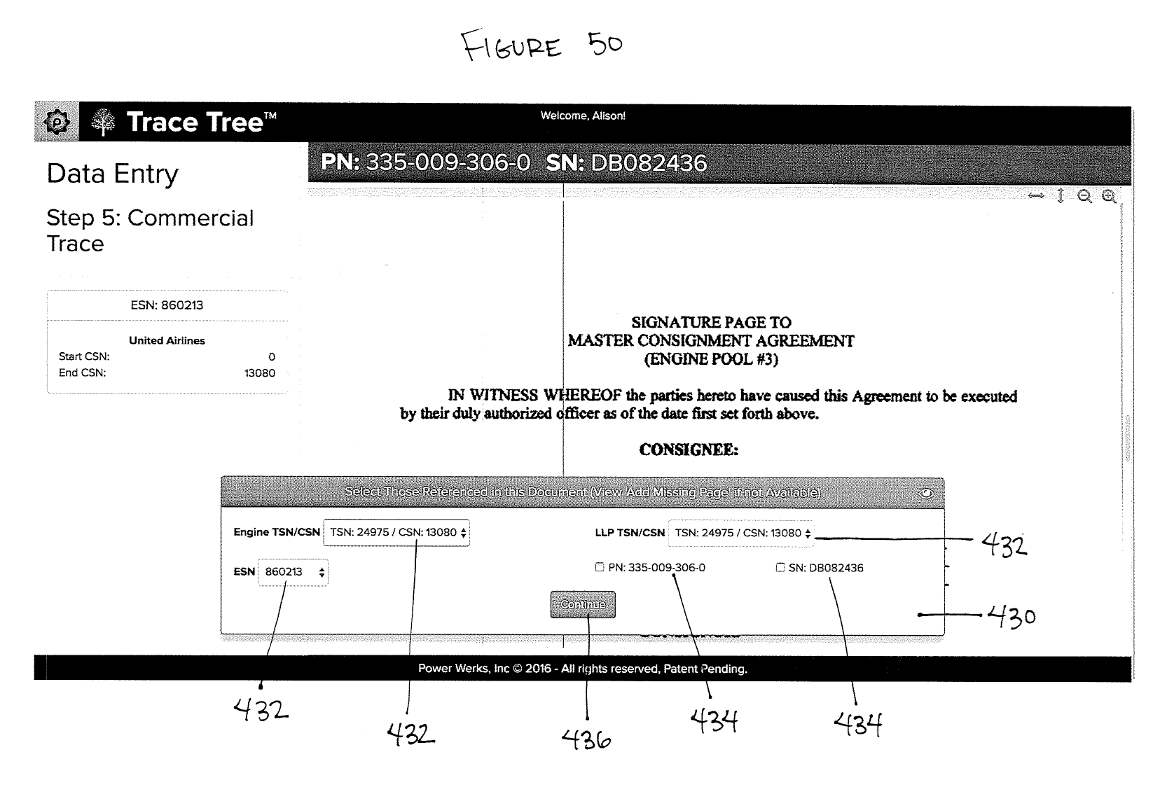

FIG. 50 shows a further dialog box 430 that asks the preparer to enter the time since new and cycles since new information shown on the document for the engine and for the part, to select the engine serial number, and to check for the part number and serial number. Pull down boxes 432 and check boxes 434 are provided for the preparer to use for this information. A continue button 436 is provided after the preparer completes this part.

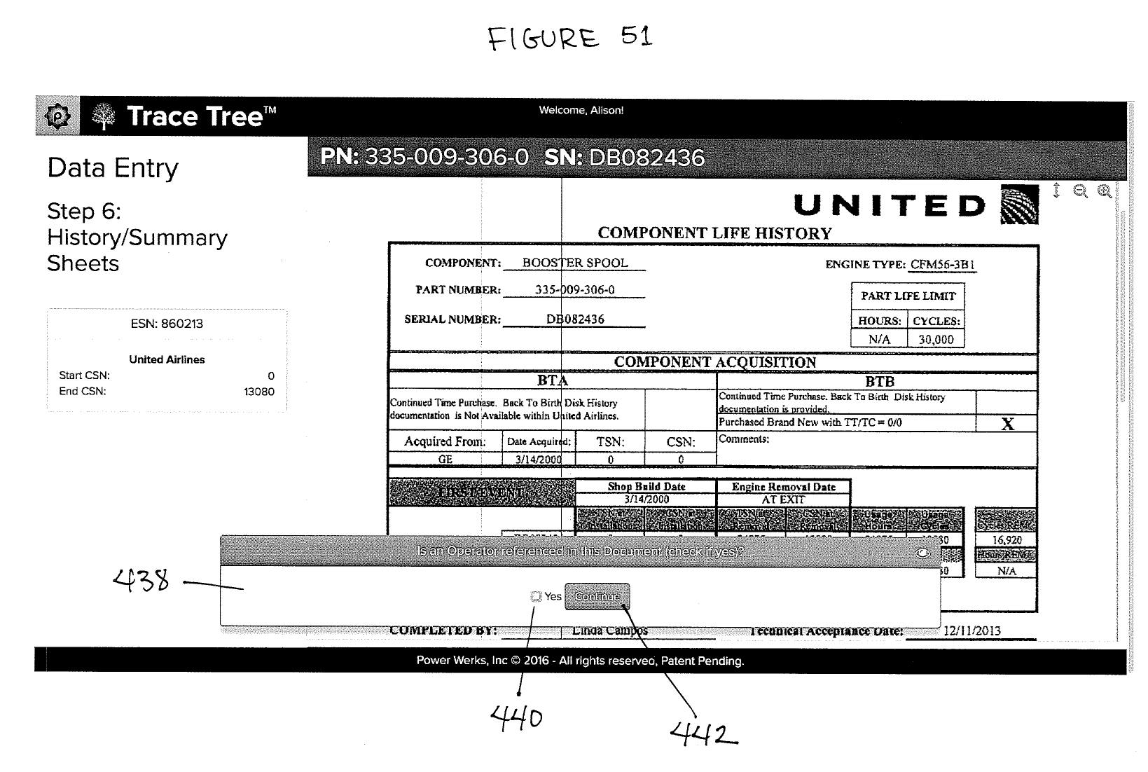

FIG. 51 shows data entry for history and summary sheets at 370. A dialog box 438 asks the preparer to confirm whether an operator is referenced in the document. A check box 440 is provided to indicate agreement. A continue button 442 continues through the preparation process.

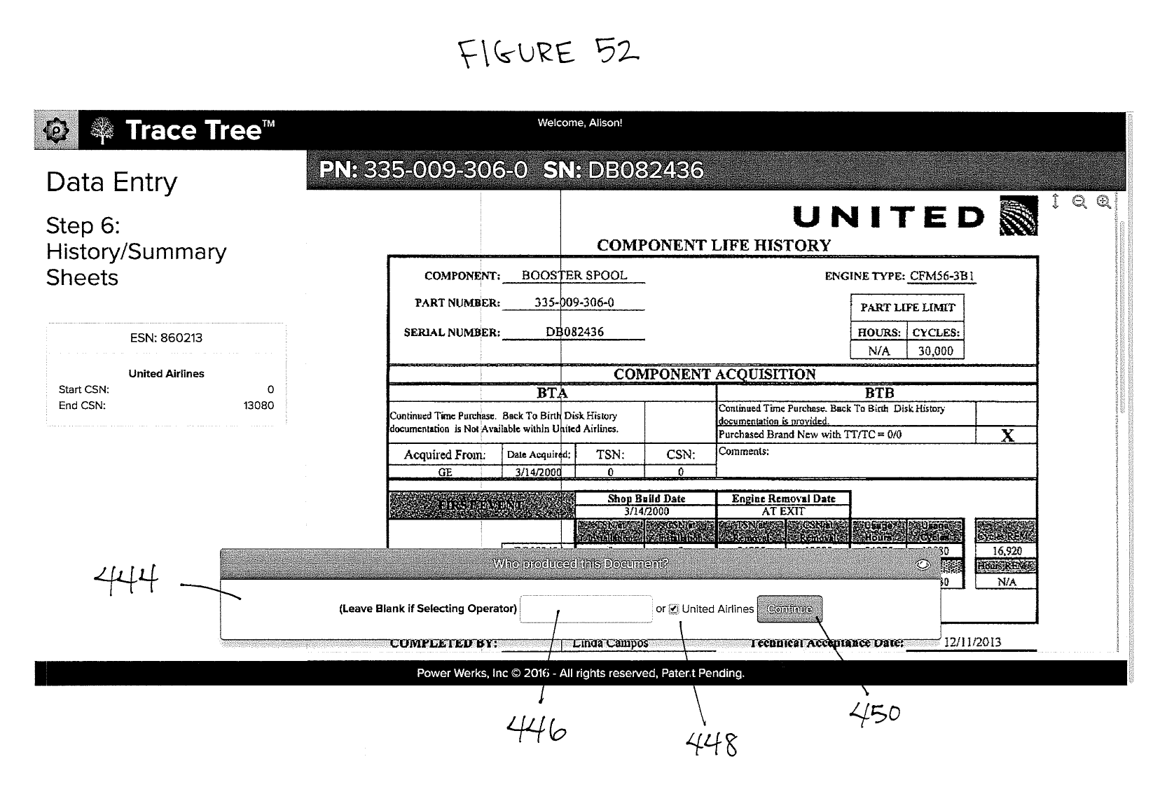

FIG. 52 shows a dialog box 444 that asks the preparer to determine who produced the displayed document. In this dialog box 44, a text entry box 446 for another entity and a check box 448 if the producer is the operator. A continue button 450 is provided.

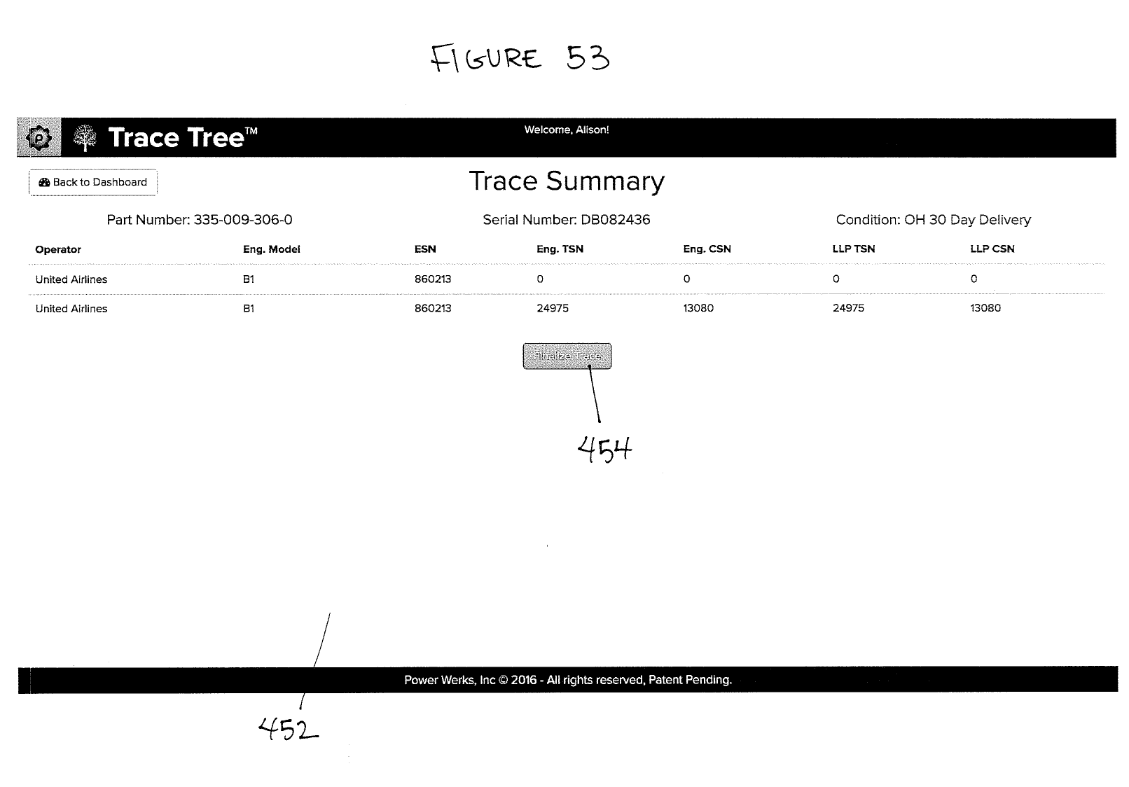

FIG. 53 shows a trace summary screen 452 with a summary of the information gathered from the document bundle preparation. A finalize trace button 454 is provided for the preparer to complete the preparation of the document bundle.

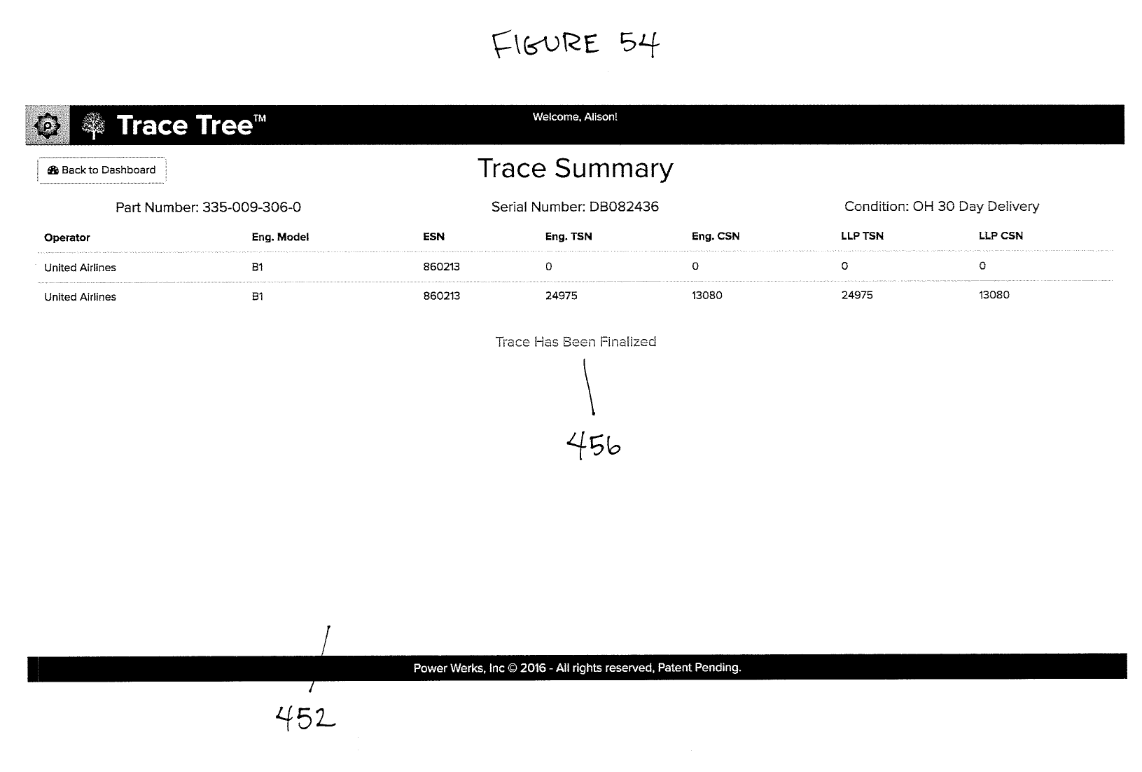

FIG. 54 shows the summary screen 452 with the indication 456 that the trace has been finalized.

The information entered by the preparer in the foregoing example is but a portion of the information to be entered into the trace document bundle for many life limited parts in order to provide the enhanced document bundle for review by the review program.

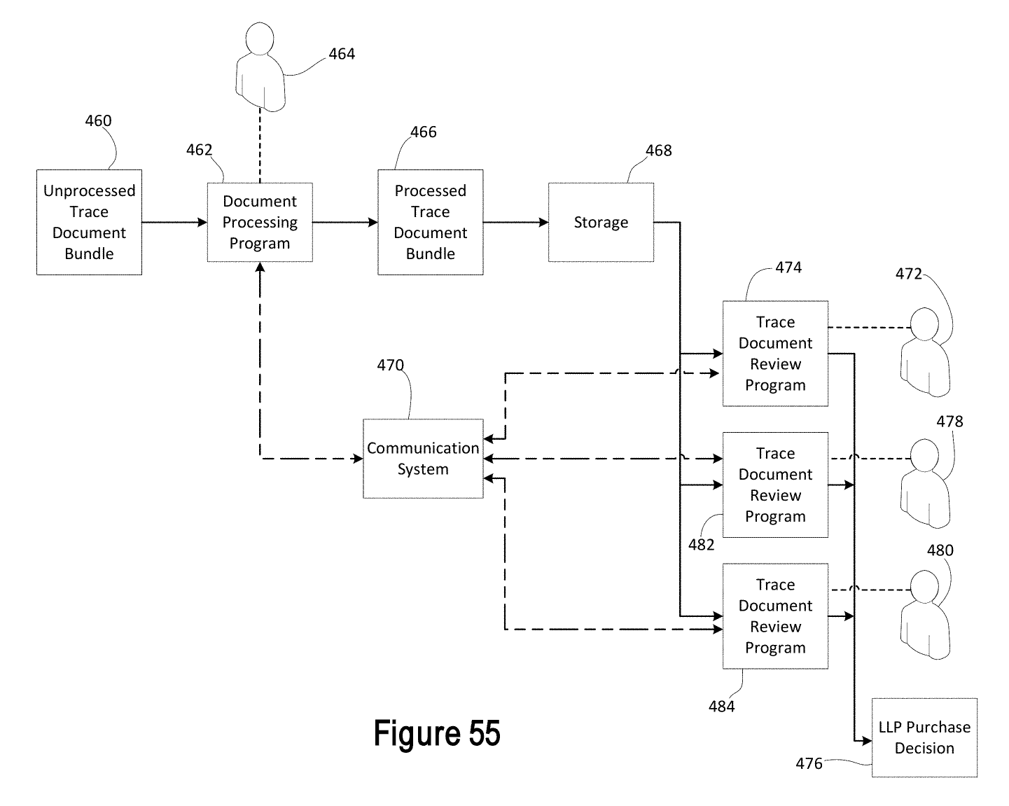

FIG. 55 shows an unprocessed trace document bundle 460 for a life limited part. The unprocessed document bundle 460 is input into a document processing program 462, such as the program shown in FIGS. 15-36. A processor 464 uses the program 462 to process the document bundle 460. Once the processor 564 and the document processing program 462 complete the processing of the document bundle 460, the program outputs it as a processed trace document bundle 466. An example of the processed trace document bundle 466 is the PowerPack™ document bundle, although the processed document bundle is not limited to this tradename. In this example, the processed document bundle 466 is sent to a storage 468 where it is stored. It is also possible that the processed document bundle 466 is reviewed directly after being processed by the program 462. The processor 464 may use the processing program 462 to designate reviewers for the processed document bundle 466, such as via a communication system 470. The communication system 470 may be built into the processing program 462 or may be separate.

When a life limited part is to be considered for purchase, the processed trace document bundle 466 is retrieved from storage 468 by a reviewer 472 using a trace document review program 474. The reviewer 472 uses the review program 474 to review the document bundle 466, for example, as shown in FIGS. 1-14 and FIGS. 37-54. At the completion of the review, the results of the review are used in a life limited part purchase decision 476.

The decision as to the purchase of the part may require that a plurality of people review the document bundle 466 for approval of the purchase. In the example shown, the purchase decision requires the approval by the reviewer 472 and two additional reviewers 478 and 480. The reviewers 478 and 480 each use an instance of the trace document program 482 and 484 to retrieve the trace document bundle 466 from the storage 468 for review. The reviewer 478 uses the review program 482 to review the document bundle 466 in a guided review. Either of the reviewers 472 or 478 may use the communication system to check on the progress of the review by the third reviewer 480. Using the tabs in the review programs 474 and 482, they can see the third reviewer's 480 progress and can send communications using the communication system 470 encouraging the third reviewer to complete the review so that the purchase decision 476 can be made. The third reviewer can send any questions or comments on the review through the communication system 470 to the other reviewers 472 or 478. Of course, this is but one example, and many others are possible within the scope of this invention.

The present invention may provide a first part that configures the bundle of documents associated with a life limited part for streamlined review. The first part includes an automated system that is active as a person examines each document in the bundle. The automated system directs sorting and identification of each of the documents and may direct highlighting or other marking portions of certain documents that contain information that may be important to a reviewer seeking to verify the history of a life limited part. The result is a document bundle that is configured for streamlined review.

The person who uses the automated system to build the streamlined document bundle need not be a technical person or a person familiar with aircraft parts, birth documents, maintenance procedures, maintenance release documents, service documents, or other documents or information found in the document bundle. For example, a clerk may prepare the streamlined document bundle, instead of requiring a trained mechanic or technician to review and prepare the bundle. The first part provides the person with a checklist and with questions and directions for methodically identifying the documents in the bundle and their contents. The documents in a part's history document bundle do not use standard formatting and so may be of a variety of different formats and types. The first part guides the person through all such documents.

The physical aircraft engines and physical aircraft parts have undergone the installations, removals and uses documented in the history documents. The history documents include physical documents recording each change in the part's history. As noted above, the physical documents may have greasy fingerprints from a mechanic as the mechanic worked on that part or the engine in which the part is used. The documents may include signatures and stamps and other marks showing for example that officials signed off on the information recorded therein. To facilitate the review that produces the streamlined document bundle, the physical documents are converted into electronic documents, such as images of the physical documents. The electronic documents are presented to the person in the first part. The electronic documents need not be in date order or in another particular order. The first part assists the person in organizing the documents in a way that facilitates review by a reviewer.

Thus, the physical parts are represented by documents, including physical documents. The physical documents are converted into electronic documents to facilitate the building of the streamlined document bundle. The streamlined document bundle chronicles the key events in the history of the physical part.

The present invention may provide a second part for use by a reviewer seeking to verify the history of the part. The second part may guide the reviewer through the document bundle, identifying and displaying documents of different types. The second part may display to the reviewer a chronological order or range covered by certain of the documents. For example, one or more of the documents may be indicated as being disk sheets covering the range of from zero to 10,000 cycles for the part. The second part may display highlighted or otherwise marked portions of the displayed documents that may be relevant to the reviewer in the verification process. The second part guides the reviewer through selected documents of the document bundle and directs the reviewer's attention to selected information in the document bundle. The reviewer need not view documents that are not relevant to that reviewer's task, nor need the reviewer review the portions of a document that may contain information not relevant to the reviewer's task. The second part identifies the type of the documents to the reviewer so that the reviewer need not spend time discovering the nature of each document. The review of the streamlined document bundle is quicker, more directed and focused on the needs of the reviewer. Tedium and confusion over the nature of different documents in the history on the part of the reviewer may be reduced or eliminated. The organization of the documents by type that is provided in the first part enables the documents to be presented to the reviewer in a logical order for that reviewer, regardless of the order of the documents in the bundle of physical documents and regardless of the order of the documents in the electronic document file. The organization of the documents permits the reviewer to view the documents in any desired order, regardless of the chronology of the events that involved the life limited part or the physical organization of the documents in the bundle. The processed document bundle may provide a standard for documents to be reviewed.

The second part may track the progress of the reviewer through the document bundle, indicating the progress of the reviewer at each completed step and showing the user each next step. The second part may provide an indicator, such as a flashing indicator, to direct the reviewer to each next level of the review. The second part leads the reviewer through the review. The reviewer can see by the progress indicator that the review is proceeding swiftly and that progress toward completion is being made. The progress display provides an incentive for the reviewer to complete the review. The organization and guidance provided by the second part in processing the streamlined bundle speeds the reviewer's progress through the bundle. The second part includes a notes function that permits a reviewer to enter notes, such as by entering text via a keyboard. The notes may be saved with the document bundle, may be forwarded to a central server, may be stored locally, and/or may be transmitted to other reviewers. The notes may relate to the documents being reviewed.

The second part may permit a reviewer to forward the streamlined document bundle to other reviewers for review and verification, including automatically sending notices or nudges for uncompleted reviews. The second part may track who the streamlined document bundle was sent to and may track the progress of each of these other reviewers through the document bundle. The tracked progress by each of the reviewers may be reported back to the sender of the streamlined document bundle. Any of the reviewers may enter notes relating to the review. The notes may be shared with some or all of the other reviewers. An administrator of the system may respond to the notes provided by reviewers and may provide corrected or replacement documents through the system. The approval or disapproval of the part may be shared with some or all of the other reviewers. For example, a first reviewer may send the streamlined document bundle to three other reviewers for approval. The first reviewer may use the second part to determine that the one of the reviewers has completed the review and approved acquisition of the part, the second reviewer has only made it part way through the bundle, and the third has not yet begun the review. The second part may be used to communicate comments between the reviewers, including comments about the documents and encouragement to the other reviewers to complete their review.

All of the documents of the original document bundle may be provided, even in the streamlined document bundle. If a reviewer has a question about an event in the part history, the reviewer can examine portions of documents that have not been highlighted or marked and can examine documents that are not designated for review in the streamline review. None of the information of the original document bundle is lost and can still be examined if desired. The streamlined document bundle configures the bundle for quick and guided review but without eliminating information from the bundle.

The second part guides reviewers through marked portions of the documents and through documents that have been identified as important to a reviewer. The guided path through the documents is provided regardless of the physical arrangement of the documents in the original bundle. The guided review presents to the viewer the history of the physical part at different times during its life.

The second part which permits one or more reviewers to review a document bundle may be used with the streamlined bundle as described above or may be used with a document bundle that has not been processed though the first part. The second part may be used by a reviewer to review the bundle of documents that represent the history of the life limited part even if the documents have not been identified by type and marked using the first part. For example, the document bundle may be in a PDF or other electronic document format. The reviewer uses the second part to move through the electronic document bundle. The second part records the progress of the reviewer through the document bundle and reports the progress to the reviewer or to other reviewers, or both.

Either the first part or the second part may break a single electronic document into multiple documents prior to review by the reviewer or otherwise prepare the document bundle for review. For example, the document bundle may include a single PDF document that includes all or most of the pages of the part history. The first part or the second part may automatically break the single document into multiple documents that each includes a separate page of the document bundle. As the reviewer progresses through the document bundle, each page is marked by the second part after the reviewer has reviewed the page or as the reviewer reviews the page. The second part indicates the progress of the review through the document bundle by indicating the progress through the separate page files.

For example, if a document bundle of a part's history is 30 pages long and has been provided as a single PDF file containing the 30 pages, the first part or the second part automatically converts the single file into 30 separate files, each including a page from the document bundle. In certain embodiments, the first part is required to create a converted document for the review, regardless of whether the review of the streamlined bundle or a conventional document bundle. As the reviewer reviews the pages of the document bundle, the reviewer's progress is tracked as a proportion of the page files reviewed. For example, if the reviewer has reviewed three pages of the 30 page document bundle, the reviewer's progress is indicated as 10% of the bundle. The indication of progress may be shown to the reviewer and/or may be shown to other reviewers or to others. The review of the documents may be performed on a computer screen or other display. The reviewer's progress may be shown on the same computer screen or display, either with the display of the documents or separately.

It is contemplated that the electronic document bundle of the part's history may be input into the second part as two or more files. Each file could be broken up into its separate pages. It is contemplated that the conversion of the electronic document bundle may include separating the documents into groups of pages. For example, the second part may determine that multiple pages belong together. It is contemplated that at least some of the separate files generated from the document bundle could contain just portions of a page from the document bundle. For example, the automatic conversion of the bundle may separate a page into two or more files.

The second part uses a split screen when viewing the streamlined bundle, showing the document type on one portion of the screen and the document on the other portion. The document bundles that have not been streamlined may lack document types that may be read by the second part, and so a single screen instead of a split screen may be used during the review.

Many reviewers prefer to print the document bundle for review rather than viewing the documents on-screen. In some examples, the printed documents or the documents for printing are referred to as a power PDF document. The second part provides a way for those who are reviewing the printed documents to track their progress as well. The second part may be provided with a print and approve button or other command. For example, the second part may provide for input of notes by the reviewer, for example, as text input entered by the reviewer that may relate to the review. The notes may be saved for the reviewer's use and/or may be transmitted to other users. The second part may generate thumbnail images of the pages of the document bundle. The thumbnail images may be shown to the reviewer so that the reviewer may indicate their progress by marking or selecting the thumbnail images of the pages that have been reviewed as printed copies. The reviewer may indicate each page being reviewed or may indicate a page within the document bundle that is or has been reviewed, as a progress marker. The progress of the review is indicated to the reviewer as well as to others. The second part may include a button or other command indicating that the part shown in the document history is approved for purchase or that it is disapproved. The approval or disapproval may be reported to other reviewers, for example.

The second part may periodically remind a prospective reviewer to review the document bundle. The second part may at least temporarily cease reminding the reviewer if the user indicates the progress of the review to the system. This serves as an encouragement for the reviewer to report on the progress of the review so that others can see the progress.

The second part thus provides the ability to share the document bundle, to review the bundle, to view the progress of a review, and to approve the document bundle, regardless of whether the document bundle has been streamlined in the first part or not. The approval or disapproval and any notes or comments by the reviewers are shared via the second part. Either a streamlined Trace Tree bundle or a conventional trace pack document bundle may be reviewed using the second part. In the second part, the progress is reported using the structure and document types of the streamlined bundle, while the bundle that has not been streamlined uses a page counting paradigm.

The second part provides a link between the paper copy and the electronic copy of the document. For the bundle reviewer who has printed a copy of the bundle, the progress through the physical paper copy is linked into the virtual copy on the computer system and reported as progress to other users. At the completion of the reviews by each of the reviewers, a decision is made as to whether to obtain the part, either through purchase or trade or otherwise. If all reviewers validate the history of the part, the part may be obtained and installed in an aircraft engine, stored, or otherwise used. If, on the other hand, the reviewer discovers discrepancies in the part history, gaps in the documents, an incident in the life of the part that is unacceptable to the reviewer, or other issues, the reviewer does not validate the part and the part is not obtained. For example, a reviewer may consider exposure to salt water by the aircraft on which the part is used as an unacceptable event regardless of the condition of the part.

In addition to communications concerning the streamlined bundle and the review of the bundle, the second part can provide communications between the reviewers and others for a wide variety of topics, including calendaring, staffing, and the like. The second part can serve for direct, closed system communication between users who wish to avoid junk email and other issues when communicating.

In the attached example, screen shots are provided of the first part as a non-technical person proceeds through a document bundle of documents relating to a life limited part to create a streamlined document bundle. The first part may be referred to as the wizard and the streamlined document bundle that results may be referred to as a PowerPack™ or trace pack.

In the attached example, screen shots are provided of the second part showing a reviewer proceeding through a review of the streamlined document bundle relating to events for a life limited part. The screen shots also show monitoring the progress of reviews of the document bundle by other reviewers.

Further details may be obtained by a review of the attached examples.

Although shown for review of parts relating to life limited parts, the present document preparation program and document review program may be used for tracking other documents and things.

Although other modifications and changes may be suggested by those skilled in the art, it is the intention of the inventors to embody within the patent warranted hereon all changes and modifications as reasonably and properly come within the scope of their contribution to the art.

I claim:

1. A method for review of a document bundle, comprising:
displaying classifications of documents in the document bundle to a first reviewer;
guiding review of the document bundle by the first reviewer, including
displaying documents within each classification to the first reviewer;
displaying received information for displayed documents;
tracking progress of the first reviewer through the documents of each classification;
forwarding the document bundle to a second reviewer;
guiding the review of the document bundle by the at least one second reviewer; and
reporting progress of the second reviewer's review to the first reviewer.

2. A method as claimed in claim 1, further comprising:
displaying progress of the first reviewers review through the document bundle to the first reviewer.

3. A method as claimed in claim 1, further comprising:
receiving recommendations for the second reviewer from the first reviewer.

4. A method as claimed in claim 1, further comprising:
simultaneously displaying an image of the document and the classification of the displayed document on a display screen.

5. A method as claimed in claim 1, further comprising:
displaying information to be located on the document by the reviewer while displaying an image of the document to the reviewer.

6. A method as claimed in claim 5, wherein the displayed information to be located is an information selected from the set of information comprising: part name, part number, part serial number, engine serial number, part time since new, part cycles since new, engine time since new, and engine cycles since new.

7. A method as claimed in claim 1, further comprising:
displaying birth documents for the life limited part to the reviewer; and
displaying removal documents for the life limited part to the reviewer.
